(19) United States
(12) Patent Application Publication
(10) Pub. No.: US 2026/0085001 A1
(43) Pub. Date: Mar. 26, 2026

(54) DURABLE PHOSPHATE GLASSES

(71) Applicant: CORNING INCORPORATED, CORNING, NY (US)

(72) Inventors: Timothy Michael Gross, Painted Post, NY (US); Alexandra Lai Ching Kao Andrews Mitchell, Ithaca, NY (US)

(21) Appl. No.: 19/305,107

(22) Filed: Aug. 20, 2025

Related U.S. Application Data
(60) Provisional application No. 63/698,129, filed on Sep. 24, 2024.

(51) Int. Cl. C03C 3/21; C03C 21/00

(52) U.S. Cl. CPC C03C 3/21; C03C 21/002

(57) ABSTRACT

A glass, comprising: 25-60 mol. % P₂O₅; 10-25 mol. % Al₂O₃; 7-27.5 mol. % K₂O; 5-27.5 mol. % Li₂O+Na₂O+K₂O; 40-65 mol. % P₂O₅+Al₂O₃+B₂O₃; >0-25 mol. % CaO+SrO+BaO; R₂O+RO+SnO₂+MnO₂>15 mol. %; ZnO<5 mol. %; and Nb₂O₅<1 mol. %; wherein R₂O is total amount in mol. % of Li₂O, Na₂O, K₂O, Rb₂O, and Cs₂O; and wherein RO is total amount in mol. % of MgO, CaO, SrO, and BaO. In some aspects, the glass is resistant to hydrolysis, including as measured according to ISO720.

### CROSS-REFERENCE TO RELATED APPLICATION

This application claims the benefit of priority under 35 U.S.C. § 119 of U.S. Provisional Application Ser. No. 63/698,129 filed on Sep. 24, 2024, the content of which is relied upon and incorporated herein by reference in its entirety.

### FIELD

The disclosure relates generally to phosphate glasses, and more particularly to transparent, chemically durable phosphate glasses having low melting temperatures and low liquidus temperatures.

### BACKGROUND

Phosphate glasses typically are not durable, especially in the wide range of uses under which they may be employed. To increase durability, exotic oxides, such as lead and iron, typically are added. However, such additives, if present in certain amounts or certain combinations, can decrease transparency or significantly increase the melting temperature of the glass. Therefore, there is a need in the art for improved phosphate glasses. This disclosure is directed toward these, as well as other, goals.

### SUMMARY

The disclosure relates, in various aspects, to glasses, comprising:

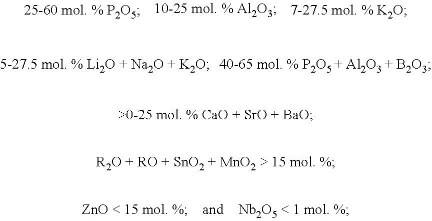

wherein R₂O is total amount in mol. % of Li₂O, Na₂O, K₂O, Rb₂O, and Cs₂O; and
wherein RO is total amount in mol. % of MgO, CaO, SrO, and BaO.

In some aspects, the glasses are resistant to hydrolysis, including as measured according to ISO720.

The disclosure relates, in various aspects, to methods for ion-exchanging glass-based substrates, the methods comprising:
ion-exchanging the glass-based substrate in an ion exchange medium to form a glass-based article,
wherein the glass-based article comprises a compressive stress layer extending from a surface of the glass-based article to a depth of compression, and the glass-based article comprises a central tension region.

The disclosure relates, in various aspects, to glass-based articles, comprising:
a compressive stress layer extending from a surface of the glass-based article to a depth of compression;
a central tension region; and
a composition at a center of the glass-based article comprises the glass disclosed herein.

Additional features and advantages of the disclosure will be set forth in the detailed description which follows, and in part will be readily apparent to those skilled in the art from that description or recognized by practicing the aspects as described herein, including the detailed description which follows, the claims, as well as the appended drawings.

It is to be understood that both the foregoing general description and the following detailed description are merely exemplary and are intended to provide an overview or framework for understanding the nature and character of the disclosure and claims. The accompanying drawings are included to provide a further understanding of the disclosure and are incorporated into and constitute a part of this specification. The drawings illustrate various aspects of the disclosure and together with the description serve to explain the principles and operations of the various aspects.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 is a graph of transmittance versus wavelength for glass composition 5 in Table 1.

FIG. 2 is a graph of percent scatter ratio (diffuse transmittance/total transmittance) versus wavelength for glass composition 5 in Table 1.

### DETAILED DESCRIPTION

In the following description, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other.

Where a range of numerical values is recited herein, comprising upper and lower values, unless otherwise stated in specific circumstances, the range is intended to include the endpoints thereof, and all integers and fractions within the range. Further, when an amount, concentration, or other value or parameter is given as a range, one or more ranges, or a list of upper values and lower values, this is to be understood as specifically disclosing all ranges formed from any pair of any upper range limit or value and any lower range limit or value, regardless of whether such pairs are separately disclosed.

The term “substantially” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue. Thus, for example, a composition that is “substantially free” of any specific component (e.g., Al₂O₃, MgO, or any other component) is one in which the component is not actively added or batched into the composition, but may be present in small amounts as a contaminant (e.g., less than 1000, 500, 400, 300, 200, or 100 ppm), or, if actively added or batched, is present in an amount less than 1 wt. % (e.g., or can be specified to be less than 0.5 wt. %, 0.1 wt. %, or 0.05 wt. %.), based on total amount of the composition (moles or mass for ppm, and mass for wt. %).

As used herein, the term “ion-exchangeable” means that a glass has a composition such that it is capable of undergoing chemical strengthening by way of ion exchange. For example, a glass having an appropriate structure and containing lithium can undergo ion exchange in a molten salt bath containing sodium and/or potassium so as to replace a portion of the lithium with sodium and/or potassium. Similarly, a glass having an appropriate structure and containing sodium can undergo ion exchange in a molten salt bath containing potassium so as to replace a portion of the sodium with potassium. As is known in the art, replacing smaller alkali ions in glass with larger alkali ions results in a compressive stress in the glass, thereby strengthening the glass. An “appropriate structure” in the glass is one that allows such ion exchange to take place so as to result in a compressive stress and associated strengthening of the glass.

As used herein, a “glass substrate” refers to a glass piece that has not been ion exchanged. Similarly, a “glass article” refers to a glass piece that has been ion exchanged and is formed by subjecting a glass substrate to an ion exchange process. A “glass-based substrate” and a “glass-based article” are defined accordingly and include glass substrates and glass articles as well as substrates and articles that are made wholly or partly of glass, such as glass substrates that include a surface coating. While glass substrates and glass articles may generally be referred to herein for the sake of convenience, the descriptions of glass substrates and glass articles should be understood to apply equally to glass-based substrates and glass-based articles.

Herein, glass compositions are expressed in terms of mol. % amounts of particular components included therein on an oxide bases unless otherwise indicated (e.g., the amounts may instead be expressed in wt. %). Any component having more than one oxidation state may be present in a glass composition in any oxidation state. However, concentrations of such component are expressed in terms of the oxide in which such component is at its lowest oxidation state unless otherwise indicated. All amounts of components of glasses herein are based on the total weight of the glass, unless specified otherwise.

As used herein, the terms “mass” and “weight” are used interchangeably without any difference in meaning intended.

As used herein, the term “>0” means “greater than zero.” Similarly, terms such as “>0-10” means “greater than zero and less than or equal to 10.” Similar meanings can be ascribed to similar terms that merely have different numbers.

As used herein, the term “liquidus viscosity” refers to the viscosity of a molten glass at the liquidus temperature, wherein the “liquidus temperature” refers to the temperature at which crystals first appear as a molten glass cools down from the melting temperature, or the temperature at which the very last crystals melt away as temperature is increased from room temperature. Unless specified otherwise, a liquidus viscosity values disclosed in this application are determined by the following method. First, the liquidus temperature of the glass is measured in accordance with ASTM C829-81 (2015), titled “Standard Practice for Measurement of Liquidus Temperature of Glass by the Gradient Furnace Method.” Next, the viscosity of the glass at the liquidus temperature is measured in accordance with ASTM C965-96 (2012), titled “Standard Practice for Measuring Viscosity of Glass Above the Softening Point”. Unless otherwise specified, the liquidus viscosity and liquidus temperature of a glass composition or article are measured before the composition or article is subjected to any ion-exchange process or any other strengthening process.

As used herein, “softening point, PPV” is an estimated softening point of a glass using parallel plate viscosity (PPV) measurements. In particular, the method measures viscosity from 10⁷ to 10⁹ poise versus temperature for inorganic glass and from these results an estimate of a nominal softening point is obtained. The measurement method relates to ASTM C1351M and involves heating a small right cylinder of glass between parallel platinum plates. As the temperature increases, the sample is viscously deformed from the load on the top plate. The relative position of the plates and the height of the sample are monitored by mechanical connection of the plates to a linear variable differential transformer (LVDT). Viscosity is calculated from the rate of change of the sample height, sample dimensions, and applied load and is presented as a function of temperature. From this curve, the softening point of the glass is estimated.

As used herein, the term “single phase glass” means that the glass is not separated into two or more distinct phases having different compositions. By contrast, “phase-separated glass” means that the glass is separated into two or more distinct phases. Phase-separation can cause the glass to scatter light, which leads to an opaque appearance to the glass. In this regard, single phase glass does not scatter light in the same way as phase-separated glass does, such that single-phase glasses do not appear opaque.

As used herein, the term “average transmittance” for a specified wavelength means the calculated average of the transmittance values of the specified wavelength range. For example, the average transmittance over a wavelength range of 400-700 means that the transmittance at each wavelength between 400-700 is summed and then divided by the total number of wavelengths between 400-700 (including the end points if such endpoints have transmittances included in the numerator summation).

Phosphate glasses are typically low melting temperature and low T_{g} glasses that generally are not chemically durable. To increase the durability of phosphate glasses, typically components such as Fe₂O₃ or a heavy metal like PbO are added, which result in black-colored and/or hazardous glass. Alternatively, the compositions are transparent but have very high melting temperatures in the range of typical silicate glasses. Thus, it is very difficult to produce transparent, durable phosphate glasses that still have low melting (200 P) temperature and low liquidus temperature.

In some aspects, disclosed herein are glasses that have one or more of (and in some aspects all of) transparency, durability, and melting and liquidus temperatures that are significantly below typical commercially-produced silicate glasses. In some aspects, the glasses herein have one or more of (and in some aspects all of): single-phase, transparent (e.g., average transmittance of at least 88% at wavelengths of 400-700 nm), high durability as determined by ISO720, high durability has determined by the 85% RH/85° C. test, low liquidus temperatures (e.g., 800-1500° C.), manufacturable by various glass forming methods (e.g., such as the gob and press process), do not contain exotic oxides (e.g., iron oxide (e.g., Fe₂O₃ and/or Fe₃O₄), PbO, CuO, or any combination thereof), or any combination thereof.

In some aspects, disclosed is a glass comprising P₂O₅, Al₂O₃, and K₂O. In some aspects, disclosed is a glass comprising P₂O₅, Al₂O₃, K₂O, a non-zero amount of Li₂O+Na₂O+K₂O, a non-zero amount of P₂O₅+Al₂O₃+B₂O₃, a non-zero amount of CaO+SrO+BaO, and a non-zero amount of R₂O+RO+SnO₂+MnO₂, in which R₂O is total amount in mol. % of Li₂O, Na₂O, K₂O, Rb₂O, and Cs₂O, and RO is total amount in mol. % of MgO, CaO, SrO, and BaO. In some aspects, the glasses contain less than 5 mol. % ZnO, and/or such glasses are free, or substantially free, of ZnO. In some aspects, the glasses contain less than 1 mol. % Nb₂O₅, and/or such glasses are free, or substantially free, of Nb₂O₅. In some aspects, the glasses contain 0.5 mol. % or less of Fe₂O₃, PbO, or a combination thereof, and/or the glasses are free, or substantially free, of Fe₂O₃, PbO, or a combination thereof.

In some aspects, disclosed are glasses comprising:

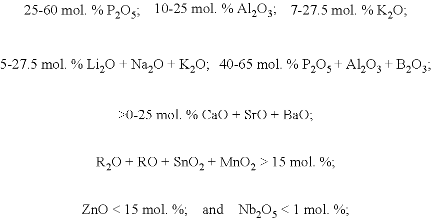

wherein R₂O is total amount in mol. % of Li₂O, Na₂O, K₂O, Rb₂O, and Cs₂O; and
wherein RO is total amount in mol. % of MgO, CaO, SrO, and BaO.

In some aspects, the glasses comprise P₂O₅. In some aspects, the glasses comprise P₂O₅ in an amount (mol. %) of at least 25, at least 30, at least 35, at least 40, at least 45, at least 50, at least 55, 60 or less, 55 or less, 50 or less, 45 or less, 40 or less, 35 or less, 30 or less, or any range formed therefrom. For example, in some aspects, the glasses comprise P₂O₅ in an amount (mol. %) of 25-60, 25-55, 25-50, 25-45, 25-40, 25-35, 25-30, 30-60, 30-55, 30-50, 30-45, 30-40, 30-35, 35-60, 35-55, 35-50, 35-45, 35-40, 40-60, 40-55, 40-50, 40-45, 45-60, 45-55, 45-50, 50-60, 50-55, or 55-60. In particular, in some aspects, the glasses comprise P₂O₅ in an amount (mol. %) of 25-60, 35 or less, 25-45, or 30-40.

In some aspects, the glasses comprise Al₂O₃. In some aspects, the glasses comprise Al₂O₃ in an amount (mol. %) of at least 10, at least 12, at least 14, at least 16, at least 18, at least 20, at least 22, at least 24, 25 or less, 24 or less, 22 or less, 20 or less, 18 or less, 16 or less, 14 or less, 12 or less, or any range formed therefrom. For example, in some aspects, the glasses comprise Al₂O₃ in an amount (mol. %) of 10-25, 10-24, 10-22, 10-20, 10-18, 10-16, 10-14, 10-12, 12-25, 12-24, 12-22, 12-20, 12-18, 12-16, 12-14, 14-25, 14-24, 14-22, 14-20, 14-18, 14-16, 16-25, 16-24, 16-22, 16-20, 16-18, 18-25, 18-24, 18-22, 18-20, 20-25, 20-24, 20-22, 22-25, 22-24, or 22-24. In particular, in some aspects, the glasses comprise Al₂O₃ in an amount (mol. %) of 10-25, 10-18, 12-20, or 12-16. In some aspects, the glasses are free of, or substantially free of, Al₂O₃.

In some aspects, the glasses comprise a sum of P₂O₅+Al₂O₃+B₂O₃. In some aspects, the glasses comprise the sum P₂O₅+Al₂O₃+B₂O₃ in an amount (mol. %) of at least 40, at least 42, at least 44, at least 46, at least 48, at least 50, at least 52, at least 54, at least 56, at least 58, at least 60, at least 62, at least 64, 65 or less, 64 or less, 62 or less, 60 or less, 58 or less, 56 or less, 54 or less, 52 or less, 50 or less, 48 or less, 46 or less, 44 or less, 42 or less, or any range formed therefrom. For example, in some aspects, the glasses comprise the sum P₂O₅+Al₂O₃+B₂O₃ in an amount (mol. %) of 40-65, 40-64, 40-62, 40-60, 40-58, 40-56, 40-54, 40-52, 40-50, 40-48, 40-46, 40-44, 40-42, 42-65, 42-64, 42-62, 42-60, 42-58, 42-56, 42-54, 42-52, 42-50, 42-48, 42-46, 42-44, 44-65, 44-64, 44-62, 44-60, 44-58, 44-56, 44-54, 44-52, 44-50, 44-48, 44-46, 46-65, 46-64, 46-62, 46-60, 46-58, 46-56, 46-54, 46-52, 46-50, 46-48, 48-65, 48-64, 48-62, 48-60, 48-58, 48-56, 48-54, 48-52, 48-50, 50-65, 50-64, 50-62, 50-60, 50-58, 50-56, 50-54, 50-52, 52-65, 52-64, 52-62, 52-60, 52-58, 52-56, 52-54, 54-65, 54-64, 54-62, 54-60, 54-58, 54-56, 56-65, 56-64, 56-62, 56-60, 56-58, 58-65, 58-64, 58-62, 58-60, 60-65, 60-64, 60-62, 62-65, 62-64, or 64-65. In particular, in some aspects, the glasses comprises the sum P₂O₅+Al₂O₃+B₂O₃ in an amount (mol. %) of 40-65, 50-60, or 48-58.

In some aspects, the glasses comprise a sum of P₂O₅+Al₂O₃. Generally, a relatively high P₂O₅+Al₂O₃ value results in a highly interconnected glass network that facilitates durability, while a relatively low P₂O₅ content facilitates achievement of lower liquidus temperatures. The P₂O₅+Al₂O₃ sum is similar to the P₂O₅+Al₂O₃+B₂O₃ sum in that it indicates how connected the network is; however, addition of B₂O₃ facilitates increased durability, provided that the glass does not phase separate (i.e., provided the glass is a single phase glass). In some aspects, the glasses comprise the sum P₂O₅+Al₂O₃ in an amount (mol. %) of at least 40, at least 42, at least 44, at least 46, at least 48, at least 50, at least 52, at least 54, at least 56, at least 58, at least 59, at least 59.5, 60 or less, 59.5 or less, 59 or less, 58 or less, 56 or less, 54 or less, 52 or less, 50 or less, 48 or less, 46 or less, 44 or less, 42 or less, or any range formed therefrom. For example, in some aspects, the glasses comprise the sum P₂O₅+Al₂O₃ in an amount (mol. %) of 40-60, 40-59.5, 40-59, 40-58, 40-56, 40-54, 40-52, 40-50, 40-48, 40-46, 40-44, 40-42, 42-60, 42-59.5, 42-59, 42-58, 42-56, 42-54, 42-52, 42-50, 42-48, 42-46, 42-44, 44-60, 44-59.5, 44-59, 44-58, 44-56, 44-54, 44-52, 44-50, 44-48, 44-46, 46-60, 46-59.5, 46-59, 46-58, 46-56, 46-54, 46-52, 46-50, 46-48, 48-60, 48-59.5, 48-59, 48-58, 48-56, 48-54, 48-52, 48-50, 50-60, 50-59.5, 50-59, 50-58, 50-56, 50-54, 50-52, 52-60, 52-59.5, 52-59, 52-58, 52-56, 52-54, 54-60, 54-59.5, 54-59, 54-58, 54-56, 56-60, 56-59.5, 56-59, 56-58, 58-60, 58-59.5, 58-59, or 59-60. In particular, in some aspects, the glasses comprise the sum P₂O₅+Al₂O₃ in an amount (mol. %) of at least 50, 40-60, 50-59.5, 44-58, or 46-56. In some aspects, P₂O₅+Al₂O₃ in an amount of at least 50 mo. % and P₂O₅ in an amount of 35 mol. % or less provide durable glasses with low liquidus temperatures.

In some aspects, the glasses comprise alkalis, such as Li₂O, Na₂O, K₂O, Rb₂O, Cs₂O, or any combination thereof. In some aspects, alkalis break up the glass structure, which can lower the liquidus temperature; however, too much alkali can result in a glass that is not very durable. In some aspects, it was found from the compositions in Table 1 in the Examples herein that the largest modifier ions, such as K⁺ and Ba²⁺, help increase durability. In addition, mixed alkalis (e.g., two or more of Li₂O, Na₂O, K₂O, Rb₂O, and Cs₂O, such as two or more of Li₂O, Na₂O, and K₂O) can result in increased durability over single alkali modifiers. In some aspects, at least two oxides selected from the group consisting of Li₂O, Na₂O, and K₂O are present.

In some aspects, the glasses comprise Li₂O. In some aspects, the glasses comprise Li₂O in an amount (mol. %) of 0, >0, at least 1, at least 2, at least 4, at least 6, at least 8, at least 10, at least 12, at least 14, 15 or less, 14 or less, 12 or less, 10 or less, 8 or less, 6 or less, 4 or less, 2 or less, 1 or less, or any range formed therefrom. For example, in some aspects, the glasses comprise Li₂O in an amount (mol. %) of 0-15, 0-14, 0-12, 0-10, 0-8, 0-6, 0-4, 0-2, 0-1, >0-15, >0-14, >0-12, >0-10, >0-8, >0-6, >0-4, >0-2, >0-1, 1-15, 1-14, 1-12, 1-10, 1-8, 1-6, 1-4, 1-2, 2-15, 2-14, 2-12, 2-10, 2-8, 2-6, 2-4, 4-15, 4-14, 4-12, 4-10, 4-8, 4-6, 6-15, 6-14, 6-12, 6-10, 6-8, 8-15, 8-14, 8-12, 8-10, 10-15, 10-14, 10-12, 12-15, 12-14, or 14-15. In particular, in some aspects, the glasses comprise Li₂O in an amount (mol. %) of 0-15, >0-10, or 5-15. In some aspects, the glasses are free, or substantially free, of Li₂O.

In some aspects, the glasses comprise Na₂O. In some aspects, the glasses comprise Na₂O in an amount (mol. %) of 0, >0, at least 2, at least 4, at least 6, at least 8, at least 10, at least 12, at least 14, at least 16, at least 18, at least 20, at least 22, at least 24, 25 or less, 24 or less, 22 or less, 20 or less, 18 or less, 16 or less, 14 or less, 12 or less, 10 or less, 8 or less, 6 or less, 4 or less, 2 or less, or any range formed therefrom. For example, in some aspects, the glasses comprise Na₂O in an amount (mol. %) of 0-25, 0-24, 0-22, 0-20, 0-18, 0-16, 0-14, 0-12, 0-10, 0-8, 0-6, 0-4, 0-2, >0-25, >0-24, >0-22, >0-20, >0-18, >0-16, >0-14, >0-12, >0-10, >0-8, >0-6, >0-4, >0-2, 2-25, 2-24, 2-22, 2-20, 2-18, 2-16, 2-14, 2-12, 2-10, 2-8, 2-6, 2-4, 4-25, 4-24, 4-22, 4-20, 4-18, 4-16, 4-14, 4-12, 4-10, 4-8, 4-6, 6-25, 6-24, 6-22, 6-20, 6-18, 6-16, 6-14, 6-12, 6-10, 6-8, 8-25, 8-24, 8-22, 8-20, 8-18, 8-16, 8-14, 8-12, 8-10, 10-25, 10-24, 10-22, 10-20, 10-18, 10-16, 10-14, 10-12, 12-25, 12-24, 12-22, 12-20, 12-18, 12-16, 12-14, 14-25, 14-24, 14-22, 14-20, 14-18, 14-16, 16-25, 16-24, 16-22, 16-20, 16-18, 18-25, 18-24, 18-22, 18-20, 20-25, 20-24, 20-22, 22-25, 22-24, or 24-25. In particular, in some aspects, the glasses comprise Na₂O in an amount (mol. %) of 0-25, >0-8, or 2-10. In some aspects, the glasses are free, or substantially free, of Na₂O.

In some aspects, the glasses comprise K₂O. In some aspects, the glasses comprise K₂O in an amount (mol. %) of 0, >0, at least 2, at least 5, at least 7, at least 10, at least 12, at least 15, at least 17, at least 20, at least 22, at least 25, at least 27, 27.5 or less, 27 or less, 25 or less, 22 or less, 20 or less, 17 or less, 15 or less, 12 or less, 10 or less, 7 or less, 5 or less, 2 or less, or any range formed therefrom. For example, in some aspects, the glasses comprise K₂O in an amount (mol. %) 0-27.5, 0-27, 0-25, 0-22, 0-20, 0-17, 0-15, 0-12, 0-10, 0-7, 0-5, 0-2, >0-27.5, >0-27, >0-25, >0-22, >0-20, >0-17, >0-15, >0-12, >0-10, >0-7, >0-5, >0-2, 2-27.5, 2-27, 2-25, 2-22, 2-20, 2-17, 2-15, 2-12, 2-10, 2-7, 2-5, 5-27.5, 5-27, 5-25, 5-22, 5-20, 5-17, 5-15, 5-12, 5-10, 5-7, 7-27.5, 7-27, 7-25, 7-22, 7-20, 7-17, 7-15, 7-12, 7-10, 10-27.5, 10-27, 10-25, 10-22, 10-20, 10-17, 10-15, 10-12, 12-27.5, 12-27, 12-25, 12-22, 12-20, 12-17, 12-15, 15-27.5, 15-27, 15-25, 15-22, 15-20, 15-17, 17-27.5, 17-27, 17-25, 17-22, 17-20, 20-27.5, 20-27, 20-25, 20-22, 22-27.5, 22-27, 22-25, 25-27.5, 25-27, or 27-27.5. In particular, in some aspects, the glasses comprise K₂O in an amount (mol. %) of 7-27.5, 12-25, or 15-23. In some aspects, the glasses are free, or substantially free, of K₂O.

In some aspects, the glasses comprise a sum of Li₂O+Na₂O+K₂O. In some aspects, the glasses comprise the sum Li₂O+Na₂O+K₂O in an amount (mol. %) of 0, >0, at least 2, at least 5, at least 7, at least 10, at least 12, at least 15, at least 17, at least 20, at least 22, at least 25, at least 27, 27.5 or less, 27 or less, 25 or less, 22 or less, 20 or less, 17 or less, 15 or less, 12 or less, 10 or less, 7 or less, 5 or less, 2 or less, or any range formed therefrom. For example, in some aspects, the glasses comprise the sum Li₂O+Na₂O+K₂O in an amount (mol. %) 0-27.5, 0-27, 0-25, 0-22, 0-20, 0-17, 0-15, 0-12, 0-10, 0-7, 0-5, 0-2, >0-27.5, >0-27, >0-25, >0-22, >0-20, >0-17, >0-15, >0-12, >0-10, >0-7, >0-5, >0-2, 2-27.5, 2-27, 2-25, 2-22, 2-20, 2-17, 2-15, 2-12, 2-10, 2-7, 2-5, 5-27.5, 5-27, 5-25, 5-22, 5-20, 5-17, 5-15, 5-12, 5-10, 5-7, 7-27.5, 7-27, 7-25, 7-22, 7-20, 7-17, 7-15, 7-12, 7-10, 10-27.5, 10-27, 10-25, 10-22, 10-20, 10-17, 10-15, 10-12, 12-27.5, 12-27, 12-25, 12-22, 12-20, 12-17, 12-15, 15-27.5, 15-27, 15-25, 15-22, 15-20, 15-17, 17-27.5, 17-27, 17-25, 17-22, 17-20, 20-27.5, 20-27, 20-25, 20-22, 22-27.5, 22-27, 22-25, 25-27.5, 25-27, or 27-27.5. In particular, in some aspects, the glasses comprise the sum Li₂O+Na₂O+K₂O in an amount (mol. %) of 5-27.5, 15-25, or 12-20. In some aspects, the glasses are free, or substantially free, of Li₂O+Na₂O+K₂O.

In some aspects, the glasses comprise CaO. In some aspects, the glasses comprise CaO in an amount (mol. %) of 0, >0, at least 1 at least 2, at least 4, at least 5, at least 6, at least 8, at least 10, at least 12, at least 14, at least 16, at least 18, 20 or less, 18 or less, 16 or less, 14 or less, 12 or less, 10 or less, 8 or less, 6 or less, 5 or less, 4 or less, 2 or less, 1 or less, or any range formed therefrom. For example, in some aspects, the glasses comprise CaO in an amount (mol. %) of 0-20, 0-18, 0-16, 0-14, 0-12, 0-10, 0-8, 0-6, 0-5, 0-4, 0-2, 0-1, >0-20, >0-18, >0-16, >0-14, >0-12, >0-10, >0-8, >0-6, >0-5, >0-4, >0-2, >0-1, 1-20, 1-18, 1-16, 1-14, 1-12, 1-10, 1-8, 1-6, 1-5, 1-4, 1-2, 2-20, 2-18, 2-16, 2-14, 2-12, 2-10, 2-8, 2-6, 2-5, 2-4, 4-20, 4-18, 4-16, 4-14, 4-12, 4-10, 4-8, 4-6, 4-5, 5-20, 5-18, 5-16, 5-14, 5-12, 5-10, 5-8, 5-6, 6-20, 6-18, 6-16, 6-14, 6-12, 6-10, 6-8, 8-20, 8-18, 8-16, 8-14, 8-12, 8-10, 10-20, 10-18, 10-16, 10-14, 10-12, 12-20, 12-18, 12-16, 12-14, 14-20, 14-18, 14-16, 16-20, 16-18, or 18-20. In particular, in some aspects, the glasses comprise CaO in an amount (mol. %) of 0-20, >0-20, >0-5, or 1-10. In some aspects, the glasses are free, or substantially free, of CaO.

In some aspects, the glasses comprise SrO. In some aspects, the glasses comprise SrO in an amount (mol. %) of 0, >0, at least 1 at least 2, at least 4, at least 5, at least 6, at least 8, at least 10, at least 12, at least 14, at least 16, at least 18, 20 or less, 18 or less, 16 or less, 14 or less, 12 or less, 10 or less, 8 or less, 6 or less, 5 or less, 4 or less, 2 or less, 1 or less, or any range formed therefrom. For example, in some aspects, the glasses comprise SrO in an amount (mol. %) of 0-20, 0-18, 0-16, 0-14, 0-12, 0-10, 0-8, 0-6, 0-5, 0-4, 0-2, 0-1, >0-20, >0-18, >0-16, >0-14, >0-12, >0-10, >0-8, >0-6, >0-5, >0-4, >0-2, >0-1, 1-20, 1-18, 1-16, 1-14, 1-12, 1-10, 1-8, 1-6, 1-5, 1-4, 1-2, 2-20, 2-18, 2-16, 2-14, 2-12, 2-10, 2-8, 2-6, 2-5, 2-4, 4-20, 4-18, 4-16, 4-14, 4-12, 4-10, 4-8, 4-6, 4-5, 5-20, 5-18, 5-16, 5-14, 5-12, 5-10, 5-8, 5-6, 6-20, 6-18, 6-16, 6-14, 6-12, 6-10, 6-8, 8-20, 8-18, 8-16, 8-14, 8-12, 8-10, 10-20, 10-18, 10-16, 10-14, 10-12, 12-20, 12-18, 12-16, 12-14, 14-20, 14-18, 14-16, 16-20, 16-18, or 18-20. In particular, in some aspects, the glasses comprise SrO in an amount (mol. %) of 0-20, >0-20, >0-5, 0-5, or 1-10. In some aspects, the glasses are free, or substantially free, of SrO.

In some aspects, the glasses comprise BaO. In some aspects, the glasses comprise BaO in an amount (mol. %) of 0, >0, at least 1 at least 2, at least 4, at least 5, at least 6, at least 8, at least 10, at least 12, at least 14, at least 16, at least 18, 20 or less, 18 or less, 16 or less, 14 or less, 12 or less, 10 or less, 8 or less, 6 or less, 5 or less, 4 or less, 2 or less, 1 or less, or any range formed therefrom. For example, in some aspects, the glasses comprise BaO in an amount (mol. %) of 0-20, 0-18, 0-16, 0-14, 0-12, 0-10, 0-8, 0-6, 0-5, 0-4, 0-2, 0-1, >0-20, >0-18, >0-16, >0-14, >0-12, >0-10, >0-8, >0-6, >0-5, >0-4, >0-2, >0-1, 1-20, 1-18, 1-16, 1-14, 1-12, 1-10, 1-8, 1-6, 1-5, 1-4, 1-2, 2-20, 2-18, 2-16, 2-14, 2-12, 2-10, 2-8, 2-6, 2-5, 2-4, 4-20, 4-18, 4-16, 4-14, 4-12, 4-10, 4-8, 4-6, 4-5, 5-20, 5-18, 5-16, 5-14, 5-12, 5-10, 5-8, 5-6, 6-20, 6-18, 6-16, 6-14, 6-12, 6-10, 6-8, 8-20, 8-18, 8-16, 8-14, 8-12, 8-10, 10-20, 10-18, 10-16, 10-14, 10-12, 12-20, 12-18, 12-16, 12-14, 14-20, 14-18, 14-16, 16-20, 16-18, or 18-20. In particular, in some aspects, the glasses comprise BaO in an amount (mol. %) of 0-20, >0-20, 10-20, or 10-18. In some aspects, the glasses are free, or substantially free, of BaO.

In some aspects, the glasses comprise a sum of CaO+SrO+BaO. In some aspects, the glasses comprises the sum CaO+SrO+BaO in an amount (mol. %) of 0, >0, at least 1, at least 2, at least 4, at least 6, at least 8, at least 10, at least 12, at least 14, at least 16, at least 18, at least 20, at least 22, at least 24, 25 or less, 24 or less, 22 or less, 20 or less, 18 or less, 16 or less, 14 or less, 12 or less, 10 or less, 8 or less, 6 or less, 4 or less, 2 or less, 1 or less, or any range formed therefrom. For example, in some aspects, the glasses comprise the sum CaO+SrO+BaO in an amount (mol. %) of 0-25, 0-24, 0-22, 0-20, 0-18, 0-16, 0-14, 0-12, 0-10, 0-8, 0-6, 0-4, 0-2, 0-1, >0-25, >0-24, >0-22, >0-20, >0-18, >0-16, >0-14, >0-12, >0-10, >0-8, >0-6, >0-4, >0-2, >0-1, 1-25, 1-24, 1-22, 1-20, 1-18, 1-16, 1-14, 1-12, 1-10, 1-8, 1-6, 1-4, 1-2, 2-25, 2-24, 2-22, 2-20, 2-18, 2-16, 2-14, 2-12, 2-10, 2-8, 2-6, 2-4, 4-25, 4-24, 4-22, 4-20, 4-18, 4-16, 4-14, 4-12, 4-10, 4-8, 4-6, 6-25, 6-24, 6-22, 6-20, 6-18, 6-16, 6-14, 6-12, 6-10, 6-8, 8-25, 8-24, 8-22, 8-20, 8-18, 8-16, 8-14, 8-12, 8-10, 10-25, 10-24, 10-22, 10-20, 10-18, 10-16, 10-14, 10-12, 12-25, 12-24, 12-22, 12-20, 12-18, 12-16, 12-14, 14-25, 14-24, 14-22, 14-20, 14-18, 14-16, 16-25, 16-24, 16-22, 16-20, 16-18, 18-25, 18-24, 18-22, 18-20, 20-25, 20-24, 20-22, 22-25, 22-24, or 24-25. In particular, in some aspects, the glasses comprise the sum CaO+SrO+BaO in an amount (mol. %) of >0-25, 14-20, or 12-18.

In some aspects, the glasses comprise a sum of R₂O+RO+SnO₂+MnO₂, in which R₂O is total amount in mol. % of Li₂O, Na₂O, K₂O, Rb₂O, and Cs₂O, and in which RO is total amount in mol. % of MgO, CaO, SrO, and BaO. In some aspects, the glasses comprises the sum R₂O+RO+SnO₂+MnO₂ in an amount (mol. %) of at least 15, at least 16, at least 18, at least 20, at least 25, at least 30, at least 35, at least 40, at least 45, at least 50, at least 55, at least 60, at least 65, 70 or less, 65 or less, 60 or less, 55 or less, 50 or less, 45 or less, 40 or less, 35 or less, 30 or less, 25 or less, 20 or less, 18 or less, 16 or less, or any range formed therefrom. For example, in some aspects, the glasses comprises the sum R₂O+RO+SnO₂+MnO₂ in an amount (mol. %) of 15-70, 15-65, 15-60, 15-55, 15-50, 15-45, 15-40, 15-35, 15-30, 15-25, 15-20, 15-18, 15-16, 16-70, 16-65, 16-60, 16-55, 16-50, 16-45, 16-40, 16-35, 16-30, 16-25, 16-20, 16-18, 18-70, 18-65, 18-60, 18-55, 18-50, 18-45, 18-40, 18-35, 18-30, 18-25, 18-20, 20-70, 20-65, 20-60, 20-55, 20-50, 20-45, 20-40, 20-35, 20-30, 20-25, 25-70, 25-65, 25-60, 25-55, 25-50, 25-45, 25-40, 25-35, 25-30, 30-70, 30-65, 30-60, 30-55, 30-50, 30-45, 30-40, 30-35, 35-70, 35-65, 35-60, 35-55, 35-50, 35-45, 35-40, 40-70, 40-65, 40-60, 40-55, 40-50, 40-45, 45-70, 45-65, 45-60, 45-55, 45-50, 50-70, 50-65, 50-60, 50-55, 55-70, 55-65, 55-60, 60-70, 60-65, or 65-70. In particular, in some aspects, the glasses comprise the sum R₂O+RO+SnO₂+MnO₂ in an amount (mol. %) of >15, >20, 16-70, or 20-55.

In some aspects, the glasses comprise ZnO. In some aspects, the glasses comprise ZnO in an amount (mol. %) of 0, >0, at least 0.1, at least 0.5, at least 1, at least 1.5, at least 2, at least 2.5, at least 3, at least 3.5, at least 4, at least 4.5, 5 or less, less than 5, 4.5 or less, 4 or less, 3.5 or less, 3 or less, 2.5 or less, 2 or less, 1.5 or less, 1 or less, 0.5 or less, 0.1 or less, or any range formed therefrom. For example, in some aspects, the glasses comprise ZnO in an amount (mol. %) of 0-5, 0-4.5, 0-4, 0-3.5, 0-3, 0-2.5, 0-2, 0-1.5, 0-1, 0-0.5, 0-0.1, >0-5, >0-4.5, >0-4, >0-3.5, >0-3, >0-2.5, >0-2, >0-1.5, >0-1, >0-0.5, >0-0.1, 0.1-5, 0.1-4.5, 0.1-4, 0.1-3.5, 0.1-3, 0.1-2.5, 0.1-2, 0.1-1.5, 0.1-1, 0.1-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. In particular, in some aspects, the glasses comprise ZnO in an amount (mol. %) of less than 5, 4.5 or less, 4 or less, 0-4, or 0-1. In some aspects, the glasses are free, or substantially free, of ZnO.

In some aspects, the glasses comprise Nb₂O₅. In some aspects, the glasses comprise Nb₂O₅ in an amount (mol. %) of 0, >0, at least 0.1, at least 0.2, at least 0.4, at least 0.6, at least 0.8, 1 or less, less than 1, 0.8 or less, 0.6 or less, 0.4 or less, 0.2 or less, 0.1 or less, or any range formed therefrom. For example, in some aspects, the glasses comprise Nb₂O₅ in an amount (mol. %) of 0-1, 0-0.8, 0-.6, 0-0.4, 0-0.2, 0-0.1, >0-1, >0-0.8, >0-0.6, >0-0.4, >0-0.2, >0-0.1, 0.1-1, 0.1-0.8, 0.1-0.6, 0.1-0.4, 0.1-0.2, 0.2-1, 0.2-0.8, 0.2-0.6, 0.2-0.4, 0.4-1, 0.4-0.8, 0.4-0.6, 0.6-1, 0.6-0.8, or 0.8-1. In particular, in some aspects, the glasses comprise Nb₂O₅ in an amount (mol. %) of less than 1, 0-1, 0-0.8, or 0-0.4. In some aspects, the glasses are free, or substantially free, of Nb₂O₅.

In some aspects, the glasses comprise B₂O₃. Generally, addition of B₂O₃ facilitates increased durability, provided that the glass does not phase separate (i.e., provided the glass is a single phase glass). In some aspects, the glasses comprise B₂O₃ in an amount (mol. %) of 0, >0, at least 1 at least 2, at least 4, at least 5, at least 6, at least 8, at least 10, at least 12, at least 14, at least 16, at least 18, 20 or less, 18 or less, 16 or less, 14 or less, 12 or less, 10 or less, 8 or less, 6 or less, 5 or less, 4 or less, 2 or less, 1 or less, or any range formed therefrom. For example, in some aspects, the glasses comprise B₂O₃ in an amount (mol. %) of 0-20, 0-18, 0-16, 0-14, 0-12, 0-10, 0-8, 0-6, 0-5, 0-4, 0-2, 0-1, >0-20, >0-18, >0-16, >0-14, >0-12, >0-10, >0-8, >0-6, >0-5, >0-4, >0-2, >0-1, 1-20, 1-18, 1-16, 1-14, 1-12, 1-10, 1-8, 1-6, 1-5, 1-4, 1-2, 2-20, 2-18, 2-16, 2-14, 2-12, 2-10, 2-8, 2-6, 2-5, 2-4, 4-20, 4-18, 4-16, 4-14, 4-12, 4-10, 4-8, 4-6, 4-5, 5-20, 5-18, 5-16, 5-14, 5-12, 5-10, 5-8, 5-6, 6-20, 6-18, 6-16, 6-14, 6-12, 6-10, 6-8, 8-20, 8-18, 8-16, 8-14, 8-12, 8-10, 10-20, 10-18, 10-16, 10-14, 10-12, 12-20, 12-18, 12-16, 12-14, 14-20, 14-18, 14-16, 16-20, 16-18, or 18-20. In particular, in some aspects, the glasses comprise B₂O₃ in an amount (mol. %) of 0-20, >0-20, 4-16, or 6-12. In some aspects, the glasses are free, or substantially free, of B₂O₃.

In some aspects, the glasses comprise TiO₂. In some aspects, the glasses comprise TiO₂ in an amount (mol. %) of 0, >0, at least 0.1, at least 0.5, at least 1, at least 2, at least 4, at least 5, at least 6, at least 8, at least 10, at least 12, at least 14, 15 or less, 14 or less, 12 or less, 10 or less, 8 or less, 6 or less, 5 or less, 4 or less, 2 or less, 1 or less, 0.5 or less, 0.1 or less, or any range formed therefrom. For example, in some aspects, the glasses comprise TiO₂ in an amount (mol. %) of 0-15, 0-14, 0-12, 0-10, 0-8, 0-6, 0-5, 0-4, 0-2, 0-1, 0-0.5, 0-0.1, >0-15, >0-14, >0-12, >0-10, >0-8, >0-6, >0-5, >0-4, >0-2, >0-1, >0-0.5, >0-0.1, 0.1-15, 0.1-14, 0.1-12, 0.1-10, 0.1-8, 0.1-6, 0.1-5, 0.1-4, 0.1-2, 0.1-1, 0.1-0.5, 0.5-15, 0.5-14, 0.5-12, 0.5-10, 0.5-8, 0.5-6, 0.5-5, 0.5-4, 0.5-2, 0.5-1, 1-15, 1-14, 1-12, 1-10, 1-8, 1-6, 1-5, 1-4, 1-2, 2-15, 2-14, 2-12, 2-10, 2-8, 2-6, 2-5, 2-4, 4-15, 4-14, 4-12, 4-10, 4-8, 4-6, 4-5, 5-15, 5-14, 5-12, 5-10, 5-8, 5-6, 6-15, 6-14, 6-12, 6-10, 6-8, 8-15, 8-14, 8-12, 8-10, 10-15, 10-14, 10-12, 12-15, 12-14, or 14-15. In particular, in some aspects, the glasses comprise TiO₂ in an amount (mol. %) of 0-15, 5-15, 2-8, or 4-12. In some aspects, the glasses are free, or substantially free, of TiO₂.

In some aspects, the glasses comprise SiO₂. In some aspects, the glasses comprise SiO₂ in an amount (mol. %) of 0, >0, at least 0.1, at least 0.5, at least 1, at least 2, at least 4, at least 5, at least 6, at least 8, at least 10, at least 12, at least 14, 15 or less, 14 or less, 12 or less, 10 or less, 8 or less, 6 or less, 5 or less, 4 or less, 2 or less, 1 or less, 0.5 or less, 0.1 or less, or any range formed therefrom. For example, in some aspects, the glasses comprise SiO₂ in an amount (mol. %) of 0-15, 0-14, 0-12, 0-10, 0-8, 0-6, 0-5, 0-4, 0-2, 0-1, 0-0.5, 0-0.1, >0-15, >0-14, >0-12, >0-10, >0-8, >0-6, >0-5, >0-4, >0-2, >0-1, >0-0.5, >0-0.1, 0.1-15, 0.1-14, 0.1-12, 0.1-10, 0.1-8, 0.1-6, 0.1-5, 0.1-4, 0.1-2, 0.1-1, 0.1-0.5, 0.5-15, 0.5-14, 0.5-12, 0.5-10, 0.5-8, 0.5-6, 0.5-5, 0.5-4, 0.5-2, 0.5-1, 1-15, 1-14, 1-12, 1-10, 1-8, 1-6, 1-5, 1-4, 1-2, 2-15, 2-14, 2-12, 2-10, 2-8, 2-6, 2-5, 2-4, 4-15, 4-14, 4-12, 4-10, 4-8, 4-6, 4-5, 5-15, 5-14, 5-12, 5-10, 5-8, 5-6, 6-15, 6-14, 6-12, 6-10, 6-8, 8-15, 8-14, 8-12, 8-10, 10-15, 10-14, 10-12, 12-15, 12-14, or 14-15. In particular, in some aspects, the glasses comprise SiO₂ in an amount (mol. %) of 0-15, >0-5, 0.1-10, or 0.5-8. In some aspects, the glasses are free, or substantially free, of SiO₂.

In some aspects, the glasses comprise Fe₂O₃, PbO, CuO, or any combination thereof in an amount (mol. %) of 0, >0, at least 0.1, at least 0.2, at least 0.4, at least 0.5, at least 0.6, at least 0.8, 1 or less, 0.8 or less, 0.6 or less, 0.5 or less, 0.4 or less, 0.2 or less, 0.1 or less, or any range formed therefrom. For example, in some aspects, the glasses comprise Fe₂O₃, PbO, CuO, or any combination thereof in an amount (mol. %) of 0-1, 0-0.8, 0-0.6, 0-0.5, 0-0.4, 0-0.2, 0-0.1, >0-1, >0-0.8, >0-0.6, >0-0.5, >0-0.4, >0-0.2, >0-0.1, 0.1-1, 0.1-0.8, 0.1-0.6, 0.1-0.5, 0.1-0.4, 0.1-0.2, 0.2-1, 0.2-0.8, 0.2-0.6, 0.2-0.5, 0.2-0.4, 0.4-1, 0.4-0.8, 0.4-0.6, 0.4-0.5, 0.5-1, 0.5-0.8, 0.5-0.6, 0.6-1, 0.6-0.8, or 0.8-1. In particular, in some aspects, the glasses comprise Fe₂O₃, PbO, CuO, or any combination thereof in an amount (mol. %) of 0.5 or less, 0.3 or less, 0-0.6, or 0-0.2. In some aspects, the glasses comprises each of Fe₂O₃ and PbO in any of the amounts specified herein, such as 0.5 mol. % or less.

In some aspects, the glasses are single-phase glasses. In some aspects, the glasses are transparent, which is facilitated by having a single phase. In some aspects, the glasses herein are phase-separated glasses have two or more distinct compositional phases.

In some aspects, the glasses have an average transmittance (%) between the wavelengths of 400-1600 nm, 400-700 nm, and/or 700-1600 nm of at least 88, at least 88.2, at least 88.4, at least 88.6, at least 88.8, at least 89, at least 89.2, at least 89.4, at least 89.6, at least 89.8, at least 90, at least 90.2, at least 90.4, at least 90.6, at least 90.8, at least 91, at least 91.5, at least 92, at least 92.5, at least 93, at least 93.5, at least 94, at least 94.5, at least 95, at least 96, at least 97, at least 98, at least 99, 100 or less, 99 or less, 98 or less, 97 or less, 96 or less, 95 or less, 94.5 or less, 94 or less, 93.5 or less, 93 or less, 92.5 or less, 92 or less, 91.5 or less, 91 or less, 90.8 or less, 90.6 or less, 90.4 or less, 90.2 or less, 90 or less, 89.8 or less, 89.6 or less, 89.4 or less, 89.2 or less, 89 or less, 88.8 or less, 88.6 or less, 88.4 or less, 88.2 or less, or any range formed therefrom. For example, in some aspects, the average transmittance (%) is 88-100, 88-97, 88-95, 88-94.5, 88-94, 88-93.5, 88-93, 88-92.5, 88-92, 88-91.5, 88-91, 88-90.8, 88-90.6, 88-90.4, 88-90.2, 88-90, 88-89.8, 88-89.6, 88-89.4, 88-89.2, 88-89, 89-100, 89-97, 89-95, 89-94, 89-93, 89-92, 89-91, 89-90, 89.6-95, 89.6-94, 89.6-93.5, 89.6-92, 89.6-91.5, 89.6-91, 89.6-90.6, 90-100, 90-97, 90-95, 90-94, 90-93, 90-92, 90-91, 91-100, 91-97, 91-95, 91-94, 91-93, 91-92, 92-100, 92-97, 92-95, 92-94, 92-93, 93-100, 93-97, 93-95, 93-94, 94-100, 94-97, 94-95, 95-100, 95-97, 97-99, or 97-100. In particular, in some aspects, the glasses have an average transmittance (%) between the wavelengths of 400-1600 nm, 400-700 nm, and/or 700-1600 nm of 88-95, 89.6-92, 90-99, or at least 90.

In some aspects, the glasses have a liquidus temperature. In some aspects, the glasses have a liquidus temperature (° C.) of at least 800, at least 850, at least 900, at least 950, at least 1000, at least 1050, at least 1100, at least 1150, at least 1200, at least 1250, at least 1300, at least 1350, at least 1400, at least 1450, at least 1500, at least 1550, 1600 or less, 1550 or less, 1500 or less, 1450 or less, 1400 or less, 1350 or less, 1300 or less, 1250 or less, 1200 or less, 1150 or less, 1100 or less, 1050 or less, 1000 or less, 950 or less, 900 or less, 850 or less, or any range formed therefrom. For example, in some aspects, the glasses have a liquidus temperature (° C.) of 800-1600, 800-1500, 800-1450, 800-1400, 800-1350, 800-1300, 800-1250, 800-1200, 800-1150, 800-1100, 800-1050, 800-1000, 800-950, 800-900, 800-850, 850-1600, 850-1500, 850-1450, 850-1400, 850-1350, 850-1300, 850-1250, 850-1200, 850-1150, 850-1100, 850-1050, 850-1000, 850-950, 850-900, 900-1600, 900-1500, 900-1450, 900-1400, 900-1350, 900-1300, 900-1250, 900-1200, 900-1150, 900-1100, 900-1050, 900-1000, 900-950, 950-1500, 950-1450, 950-1400, 950-1350, 950-1300, 950-1250, 950-1200, 950-1150, 950-1100, 950-1050, 950-1000, 1000-1600, 1000-1500, 1000-1450, 1000-1400, 1000-1350, 1000-1300, 1000-1250, 1000-1200, 1000-1150, 1000-1100, 1000-1050, 1050-1500, 1050-1450, 1050-1400, 1050-1350, 1050-1300, 1050-1250, 1050-1200, 1050-1150, 1050-1100, 1100-1600, 1100-1500, 1100-1450, 1100-1400, 1100-1350, 1100-1300, 1100-1250, 1100-1200, 1100-1150, 1150-1500, 1150-1450, 1150-1400, 1150-1350, 1150-1300, 1150-1250, 1150-1200, 1200-1600, 1200-1500, 1200-1450, 1200-1400, 1200-1350, 1200-1300, 1200-1250, 1250-1500, 1250-1450, 1250-1400, 1250-1350, 1250-1300, 1300-1600, 1300-1500, 1300-1450, 1300-1400, 1300-1350, 1350-1500, 1350-1450, 1350-1400, 1400-1600, 1400-1500, 1400-1450, or 1450-1500. In particular, in some aspects, the glasses have a liquidus temperature (° C.) of 800-1600, 800-1500, 800-1200, or 850-1100.

In some aspects, the glasses described herein may be selected to have liquidus viscosities that are compatible with existing glass forming techniques. In some aspects, the glasses have a liquidus viscosity (P) of at least 50, at least 100, at least 150, at least 200, at least 250, at least 300, at least 350, at least 400, at least 450, at least 500, at least 550, at least 600, at least 650, 700 or less, 650 or less, 600 or less, 550 or less, 500 or less, 450 or less, 400 or less, 350 or less, 300 or less, 250 or less, 200 or less, 150 or less, 100 or less, or any range formed therefrom. For example, in some aspects, the glasses have a liquidus viscosity (P) of 50-700, 50-650, 50-600, 50-550, 50-500, 50-450, 50-400, 50-350, 50-300, 50-250, 50-200, 50-150, 50-100, 100-700, 100-550, 100-400, 100-350, 100-300, 100-250, 100-150, 150-700, 150-600, 150-500, 150-450, 150-400, 150-350, 150-300, 150-250, 150-200, 200-700, 200-600, 200-500, 200-450, 200-400, 200-350, 200-300, 200-250, 200-700, 200-650, 200-550, 200-450, 200-400, 200-350, 200-300, 200-250, 250-700, 250-600, 250-500, 250-450, 250-400, 250-350, 250-300, 300-700, 300-600, 300-500, 300-450, 300-400, 300-350, 350-700, 350-600, 350-500, 350-450, 350-400, 400-700, 400-600, 400-500, 400-450, 450-700, 450-650, 450-600, 450-550, 450-500, 500-700, 500-650, 500-600, 500-550, 550-700, 550-600, 600-700, 600-650, or 650-700. In particular, in some aspects, the glasses have a liquidus viscosity (P) of 50-350, 50-300, 100-350, or 100-400.

In some aspects, the glasses have a temperature (° C.) at 200 P. The temperature at 200 P is the temperature of a glass when it has a viscosity of 200 P. In some aspects, the glasses have a temperature (° C.) at 200 P of at least 700, at least 750, at least 800, at least 850, at least 900, at least 950, 1000 or less, 950 or less, 900 or less, 850 or less, 800 or less, 750 or less, or any range formed therefrom. For example, in some aspects, the glasses have a temperature (° C.) at 200 P of 700-1000, 700-950, 700-900, 700-850, 700-800, 700-750, 750-1000, 750-950, 750-900, 750-850, 750-800, 800-1000, 800-950, 800-900, 800-850, 850-1000, 850-950, 850-900, 900-1000, 900-950, or 950-1000. In particular, in some aspects, the glasses have a temperature (° C.) at 200 P of 700-1000, 750-1000, 750-950, 750-850, or 800-900.

In some aspects, the glasses exhibit durability. In some aspects, the glasses exhibit a hydrolytic resistance. In some aspects, the durability and/or hydrolytic resistance is determined by ISO720, an 85% RH/85° C. test, or a combination thereof, as described in more detail elsewhere herein. In some aspects, the glasses exhibit HGA1 hydrolytic resistance, HGA2 hydrolytic resistance, or HGA3 hydrolytic resistance, according to ISO720. “HGA” stands for the hydrolytic resistance of glass grains according to an autoclave test method, as described in more detail elsewhere herein. In some aspects, the glasses exhibit a type HGA1 hydrolytic resistance, a type HGA2 hydrolytic resistance, or a type HGA3 hydrolytic resistance, according to ISO720. In some aspects, the glasses exhibit a type HGA1 hydrolytic resistance or a type HGA2 hydrolytic resistance. In some aspects, the glasses exhibit a type HGA1 hydrolytic resistance. A glass exhibiting a type HGA1 hydrolytic resistance is more durable (e.g., more resistant to hydrolysis) relative to an HGA2 glass or an HGA3 glass. Similarly, a glass exhibiting type HGA2 hydrolytic resistance is more durable (e.g., more resistant to hydrolysis) relative to an HGA3 glass.

The 85% RH/85° C. test is performed on a glass as described elsewhere herein. In some aspects, a glass exhibits no visible changes in appearance after subjecting the glass to 85% relative humidity and 85° C. for a period of 24 hours, 7 days, 14 days, or 21 days, as determined by an ordinary observer without any visual aids except ordinary eyeglasses if needed. As used herein, the phrase “as determined by an ordinary observer without any visual aids except ordinary eyeglasses if needed” means a visual inspection is performed without use of, for example, microscopes or other analysis apparatus. Rather, an ordinary observer inspects the glass after such test with their naked eye (or with ordinary eyeglasses, which can be reading glasses, so as to aid the ordinary observer with their “naked eye” inspection).

In some aspects, the glasses described herein may form glass-based substrates or glass-based articles that exhibit an amorphous microstructure and may be substantially free of crystals or crystallites. In other words, in some aspects, the glass-based substrates or glass-based articles formed from the glass compositions described herein may exclude ceramic or glass-ceramic materials. In other aspects, the glass compositions described herein may form glass-based substrates or glass-based articles that comprise crystals or crystallites, such that the glass-based substrates or glass-based articles in some aspects include ceramic or glass-ceramic materials.

In some aspects, the glasses are ion-exchangeable. In some aspects, compressive stress layers may be formed in a glass-based substrate by exposing the glass-based substrate to one or more ion exchange media. For example, in some aspects, disclosed is a method for ion-exchanging a glass-based substrate, the method comprising:
ion-exchanging the glass-based substrate in an ion exchange medium to form a glass-based article,
wherein the glass-based article comprises a compressive stress layer extending from a surface of the glass-based article to a depth of compression, the glass-based article comprises a central tension region, and the glass-based substrate comprises any of the glasses disclosed herein.

In some aspects, an ion exchange medium may be a molten salt bath, such as a bath containing a molten nitrate salt. In some aspects, an ion exchange medium may be a molten salt bath (e.g., the first molten salt bath) including KNO₃, NaNO₃, Ca(NO₃)₂, K₂CO₃, Na₂CO₃, or any combination thereof. In some aspects, other sodium and potassium salts may be used in an ion exchange medium, such as, for example sodium or potassium nitrites, phosphates, or sulfates. In some aspects, an ion exchange medium may include lithium salts, such as LiNO₃. An ion exchange medium may additionally include additives commonly included when ion exchanging glass, such as silicic acid. In some aspects, the ion exchange process is applied to a glass-based substrate to form a glass-based article that includes a compressive stress layer extending from a surface of the glass-based article to a depth of compression and a central tension region. The glass-based substrate utilized in an ion exchange process may comprise any of the glasses described herein. In some aspects, a single molten salt bath (e.g., the first molten salt bath) may be used to ion exchange a glass-based substrate. In some aspects, more than one molten salt bath (e.g., the first molten salt bath followed by a second, third, or fourth molten salt bath) may be used to ion exchange a glass-based substrate. Any of the disclosures herein relating to a molten salt bath or first molten salt bath may be equally applied to, and used to describe, a second or subsequent molten salt bath(s). In some aspects, the the ion exchange medium comprises a molten salt bath comprising NaNO₃, KNO₃, or a combination thereof.

In some aspects, a molten salt bath (e.g., the first molten salt bath) comprises KNO₃. In some aspects, the amount (wt. %) of KNO₃ is at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, 100 or less, 95 or less, 90 or less, 85 or less, 80 or less, 75 or less, 70 or less, 65 or less, 60 or less, 55 or less, 50 or less, 45 or less, 40 or less, 35 or less, 30 or less, 25 or less, 20 or less, 15 or less, or any range formed therefrom. For example, in some aspects, a molten salt bath (e.g., the first molten salt bath) comprises KNO₃ in an amount (wt. %) of 10-100, 10-90, 10-80, 10-70, 10-60, 10-50, 10-40, 10-30, 10-25, 10-20, 10-15, 15-100, 15-85, 15-45, 15-30, 15-25, 15-20, 20-100, 20-80, 20-60, 20-50, 20-45, 20-35, 20-25, 25-100, 25-85, 25-75, 25-60, 25-55, 25-45, 25-30, 30-100, 30-95, 30-80, 30-70, 30-60, 30-50, 30-40, 35-100, 35-95, 35-85, 35-70, 35-60, 35-50, 35-45, 40-100, 40-85, 40-60, 40-55, 40-50, 45-100, 45-80, 45-60, 45-55, 50-100, 50-80, 50-60, 60-100, 60-85, 60-70, 70-100, 70-90, 70-80, 80-100, 80-90, or 80-100. In particular, in some aspects, a molten salt bath (e.g., the first molten salt bath) comprises KNO₃ in an amount (wt. %) 10-100, 40-80, or 90-100. It is explicitly contemplated that KNO₃ can be present in a molten salt bath with any other component mentioned herein, such as NaNO₃, Ca(NO₃)₂, and/or silicic acid, for example, in any of the amounts disclosed for such components.

In some aspects, a molten salt bath (e.g., the first molten salt bath) comprises NaNO₃. In some aspects, the amount (wt. %) of NaNO₃ is at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, 100 or less, 95 or less, 90 or less, 85 or less, 80 or less, 75 or less, 70 or less, 65 or less, 60 or less, 55 or less, 50 or less, 45 or less, 40 or less, 35 or less, 30 or less, 25 or less, 20 or less, 15 or less, or any range formed therefrom. For example, in some aspects, a molten salt bath (e.g., the first molten salt bath) comprises NaNO₃ in an amount (wt. %) of 10-100, 10-90, 10-80, 10-60, 10-55, 10-35, 10-25, 10-20, 20-100, 20-95, 20-85, 20-70, 20-65, 20-50, 20-40, 20-30, 30-100, 30-90, 30-70, 30-55, 30-45, 30-40, 40-100, 40-85, 40-70, 40-65, 40-60, 40-50, 50-100, 50-90, 50-80, 50-60, 60-100, 60-85, 60-75, 60-70, 70-100, 70-85, 70-80, 80-100, 80-90, or 90-100. In particular, in some aspects, a molten salt bath (e.g., the first molten salt bath) comprises NaNO₃ in an amount (wt. %) of 60-100, 20-90, or 40-80. It is explicitly contemplated that NaNO₃ can be present in a molten salt bath with any other component mentioned herein, such as KNO₃, Ca(NO₃)₂, and/or silicic acid, for example, in any of the amounts disclosed for such components.

In some aspects, a molten salt bath (e.g., the first molten salt bath) comprises Ca(NO₃)₂. In some aspects, the amount (wt. %) of Ca(NO₃)₂ is at least 30, at least 35, at least 40, at least 45, at least 50, at least 55, at least 60, at least 65, at least 70, at least 75, at least 80, at least 85, at least 90, at least 95, 99 or less, 95 or less, 90 or less, 85 or less, 80 or less, 75 or less, 70 or less, 65 or less, 60 or less, 55 or less, 50 or less, 45 or less, 40 or less, 35 or less, or any range formed therefrom. For example, in some aspects, the amount (wt. %) of Ca(NO₃)₂ is 30-99, 30-95, 30-90, 30-85, 30-80, 30-70, 30-60, 30-45, 30-40, 40-99, 40-90, 40-80, 40-70, 40-50, 50-99, 50-90, 50-75, 50-70, 50-60, 60-99, 60-90, 60-75, 60-70, 70-99, 70-95, 70-90, 70-80, 80-99, 80-95, 80-90, 85-99, 85-95, 85-90, or 90-99. In particular, in some aspects, the amount (wt. %) of Ca(NO₃)₂ is 50-99, 40-80, or 60-95. It is explicitly contemplated that Ca(NO₃)₂ can be present in a molten salt bath with any other component mentioned herein, such as KNO₃, NaNO₃, and/or silicic acid, for example, in any of the amounts disclosed for such components.

In some aspects, the ion exchange medium comprises a molten salt bath comprising a mixed salt eutectic bath comprising KNO₃ and Ca(NO₃)₂. In a eutectic bath comprising KNO₃ and Ca(NO₃)₂, the melting point of the bath can be lowered to about 150° C. Provided at least a portion, or most or all, of KNO₃ is melted and present in liquid, then the K⁺ ions can diffuse into the glass-based substrate (even if there is some solid Ca(NO₃)₂ present, since Ca²⁺ does not participate in ion exchange to any significant degree). This allowed ion exchange to be performed at relatively lower temperatures.

In some aspects, the amount of KNO₃ and Ca(NO₃)₂ in the ion exchange medium can be expressed by combining any of the amounts disclosed herein for KNO₃ and Ca(NO₃)₂. In some aspects, the amounts of KNO₃ and Ca(NO₃)₂ can be expressed in mole fraction of KNO₃ relative to KNO₃+Ca(NO₃)₂. In some aspects, the mole fraction of KNO₃ relative to KNO₃+Ca(NO₃)₂ is at least 0.05, at least 0.1, at least 0.15, at least 0.2, at least 0.25, at least 0.3, at least 0.35, at least 0.4, at least 0.45, at least 0.5, at least 0.55, at least 0.6, at least 0.65, at least 0.7, 0.75 or less, 0.7 or less, 0.65 or less, 0.6 or less, 0.55 or less, 0.5 or less, 0.45 or less, 0.4 or less, 0.35 or less, 0.3 or less, 0.25 or less, 0.2 or less, 0.15 or less, 0.1 or less, or any range formed therefrom. For example, in some aspects, the mole fraction of KNO₃ relative to KNO₃+Ca(NO₃)₂ is 0.05-0.75, 0.05-0.7, 0.05-0.65, 0.05-0.6, 0.05-0.55, 0.05-0.5, 0.05-0.45, 0.05-0.4, 0.05-0.35, 0.05-0.3, 0.05-0.25, 0.05-0.2, 0.05-0.15, 0.05-0.1, 0.1-0.75, 0.1-0.65, 0.1-0.6, 0.1-0.55, 0.1-0.45, 0.1-0.35, 0.1-0.2, 0.2-0.75, 0.2-0.65, 0.2-0.6, 0.2-0.5, 0.2-0.4, 0.2-0.35, 0.2-0.3, 0.3-0.75, 0.3-0.65, 0.3-0.6, 0.3-0.55, 0.3-0.4, 0.4-0.75, 0.4-0.7, 0.4-0.6, 0.4-0.5, 0.5-0.75, 0.5-0.65, 0.5-0.6, 0.6-0.75, 0.6-0.7, 0.6-0.65, or 0.65-0.7. In particular, in some aspects, the mole fraction of KNO₃ relative to KNO₃+Ca(NO₃)₂ is 0.05-0.75, 0.05-0.65, 0.55-0.65, or 0.5-0.7.

In some aspects, in some aspects, the ion exchange is performed at a temperature (° C.) of at least 150, at least 200, at least 250, at least 300, at least 350, at least 400, at least 450, at least 500, 550 or less, 500 or less, 450 or less, 400 or less, 350 or less, 300 or less, 250 or less, 200 or less, or any range formed therefrom. For example, in some aspects, the ion-exchange is performed at a temperature (° C.) of 150-550, 150-500, 150-450, 150-400, 150-350, 150-300, 150-250, 150-200, 200-550, 200-500, 200-450, 200-400, 200-350, 200-300, 200-250, 250-550, 250-500, 250-450, 250-400, 250-350, 250-300, 300-550, 300-500, 300-450, 300-400, 300-350, 350-550, 350-500, 350-450, 350-400, 400-550, 400-500, 400-450, 450-550, 450-500, or 500-550. In particular, in some aspects, the ion exchange is performed at a temperature (° C.) of 150-550, 150-450, 150-300, or 150-250.

In some aspects, the ion exchange is performed at a temperature that is lower than the strain point of the glass-based substrate. In some aspects, the ion exchange is performed at a temperature (° C.) that is lower than the strain point of the glass-based substrate by X, in which X is at least 25, at least 50, at least 75, at least 100, at least 125, at least 150, 175 or less, 150 or less, 125 or less, 100 or less, 75 or less, 50 or less, or any range formed therefrom. For example, in some aspects, the ion exchange is performed at a temperature (° C.) that is lower than the strain point of the glass-based substrate by X, in which X is 25-175, 25-150, 25-125, 25-100, 25-75, 25-50, 50-175, 50-150, 50-125, 50-100, 50-75, 75-175, 75-150, 75-125, 75-100, 100-175, 100-150, 100-125, 125-175, 125-150, or 150-175. In particular, in some aspects, X is 25-175, 50-150, or 75-125. For example, if the strain point of a glass-based substrate is 450° C., then in some aspects the ion exchange would be performed at a temperature (° C.) of 450-X, in which X is any of the aforementioned ranges (e.g., if X is 75-125° C., then the temperature of the ion exchange would be 450 minus (75 to 125), which equals 325-375° C.).

In some aspects, the ion exchange is performed for a time period (hours) suitable for providing a suitable depth of compression for the intended application. In some aspects, the time period (hours) is at least 2, at least 4, at least 6, at least 8, at least 10, at least 12, at least 14, 16 or less, 14 or less, 12 or less, 10 or less, 8 or less, 6 or less, 4 or less, or any range formed therefrom. For example, in some aspects, the ion exchange is performed for a time period (hours) of 2-16, 2-14, 2-12, 2-10, 2-8, 2-6, 2-4, 4-16, 4-14, 4-12, 4-10, 4-8, 4-6, 6-16, 6-14, 6-12, 6-10, 6-8, 8-16, 8-14, 8-12, 8-10, 10-16, 10-14, 10-12, 12-16, 12-14, or 14-16. In particular, in some aspects, the ion exchange is performed for a time period (hours) of 2-16, 2-12, 2-8, or 4-10.

In some aspects, disclosed is a glass-based article comprising:
a compressive stress layer extending from a surface of the glass-based article to a depth of compression;
a central tension region; and
a composition at a center of the glass-based article comprising any of the glasses disclosed herein.

Various aspects are contemplated herein, several of which are set forth in the paragraphs below. It is explicitly contemplated that any aspect or portion thereof can be combined to form a combination. The phrase “any other aspect herein” means any numbered aspect herein, or any aspect or aspects disclosed elsewhere herein.

Aspect 1: A glass, comprising:

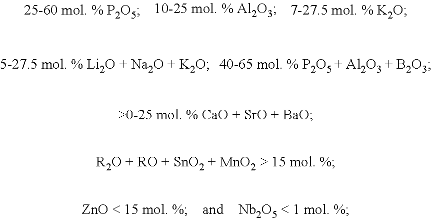

wherein R₂O is total amount in mol. % of Li₂O, Na₂O, K₂O, Rb₂O, and Cs₂O; and
wherein RO is total amount in mol. % of MgO, CaO, SrO, and BaO.

Aspect 2: The glass of any preceding aspect, or any other aspect herein, wherein the glass is a single-phase glass.

Aspect 3: The glass of any preceding aspect, or any other aspect herein, wherein the glass has an average transmittance of at least 88% from 400 nm to 700 nm.

Aspect 4: The glass of any preceding aspect, or any other aspect herein, comprising a liquidus temperature of 800-1600° C.

Aspect 5: The glass of any preceding aspect, or any other aspect herein, comprising a temperature at 200 P of 700-1000° C.

Aspect 6: The glass of any preceding aspect, or any other aspect herein, wherein the glass exhibits a type HGA1 or HGA 2 hydrolytic resistance according to ISO 720.

Aspect 7: The glass of any preceding aspect, or any other aspect herein, wherein the glass exhibits a type HGA1 hydrolytic resistance according to ISO 720.

Aspect 8: The glass of any preceding aspect, or any other aspect herein, wherein the glass exhibits no visible changes in appearance after subjecting the glass to 85% relative humidity and 85° C. for a period of 7 days, as determined by an ordinary observer without any visual aids except ordinary eyeglasses if needed.

Aspect 9: The glass of any preceding aspect, or any other aspect herein, wherein P₂O₅+Al₂O₃ is present in an amount of 50-59.5 mol. %.

Aspect 10: The glass of any preceding aspect, or any other aspect herein, wherein P₂O₅ is present in an amount of 35 mol. % or less.

Aspect 11: The glass of any preceding aspect, or any other aspect herein, wherein at least two oxides selected from the group consisting of Li₂O, Na₂O, and K₂O are present.

Aspect 12: The glass of any preceding aspect, or any other aspect herein, wherein:
P₂O₅ is present in an amount of 25-45 mol. %;
Al₂O₃ is present in an amount of 10-20 mol. %;
K₂O is present in an amount of 12-25 mol. %;
Li₂O+Na₂O+K₂O is present in an amount of 15-25 mol. %;
P₂O₅+Al₂O₃+B₂O₃ is present in an amount of 50-60 mol. %;
CaO+SrO+BaO is present in an amount of 14-20 mol. %; and
R₂O+RO+SnO₂+MnO₂ is present in an amount of 16-70 mol. %;
wherein R₂O is total amount in mol. % of Li₂O, Na₂O, K₂O, Rb₂O, and Cs₂O; and
wherein RO is total amount in mol. % of MgO, CaO, SrO, and BaO.

Aspect 13: The glass of any preceding aspect, or any other aspect herein:
wherein B₂O₃ is present in an amount of 0-20 mol. %;
wherein Li₂O is present in an amount of 0-15 mol. %;
wherein Na₂O is present in an amount of 0-25 mol. %;
wherein CaO is present in an amount of 0-20 mol. %;
wherein SrO is present in an amount of 0-20 mol. %;
wherein BaO is present in an amount of 0-20 mol. %;
wherein TiO₂ is present in an amount of 0-15 mol. %; and
wherein SiO₂ is present in an amount of 0-15 mol. %.

Aspect 14: The glass of any preceding aspect, or any other aspect herein, wherein:
wherein P₂O₅ is present in an amount 25-45 mol. %;
wherein Al₂O₃ is present in an amount 10-18 mol. %;
wherein K₂O is present in an amount 15-23 mol. %;
wherein BaO is present in an amount 10-20 mol. %;
wherein TiO₂ is present in an amount 5-15; and
wherein SiO₂ is present in an amount >0-5 mol. %;

Aspect 15: The glass of any preceding aspect, or any other aspect herein, wherein at least one of the following is satisfied:
wherein B₂O₃ is present in an amount of 4-16 mol. %;
wherein Li₂O is present in an amount of >0-10 mol. %;
wherein Na₂O is present in an amount of >0-8 mol. %;
wherein CaO is present in an amount of >0-5 mol. %;
wherein SrO is present in an amount of 0-5 mol. %;
wherein BaO is present in an amount of 10-18 mol. %;
wherein TiO₂ is present in an amount of 2-8 mol. %;
wherein SiO₂ is present in an amount of >0-5 mol. %;
or any combination thereof.

Aspect 16: The glass of any preceding aspect, or any other aspect herein, comprising 0.5 mol. % or less of each of Fe₂O₃ and PbO.

Aspect 17: A method for ion-exchanging a glass-based substrate, the method comprising:
ion-exchanging the glass-based substrate in an ion exchange medium to form a glass-based article,
wherein the glass-based article comprises a compressive stress layer extending from a surface of the glass-based article to a depth of compression, the glass-based article comprises a central tension region, and the glass-based substrate comprises the glass of any preceding aspect, or any other aspect herein.

Aspect 18: The method of aspect 17, or any other aspect herein, wherein the ion exchange medium comprises a molten salt bath comprising NaNO₃, KNO₃, Ca(NO₃)₂, or any combination thereof.

Aspect 19: The method of aspect 17 or 18, or any other aspect herein, wherein the ion exchange medium comprises a molten salt bath comprising a mixed salt eutectic bath comprising KNO₃ and Ca(NO₃)₂.

Aspect 20: The method of any one of aspects 17-19, or any other aspect herein, wherein the ion-exchanging is conducted at a temperature of 150-550° C. for a time period of 2-16 hours.

Aspect 21: The method of any one of aspects 17-20, or any other aspect herein, wherein the ion-exchanging is conducted at a temperature of 150-450° C. for a time period of 2-12 hours

Aspect 22: A glass-based article, comprising:
a compressive stress layer extending from a surface of the glass-based article to a depth of compression;
a central tension region; and
a composition at a center of the glass-based article comprising the glass of any one of aspects 1-16, or any other aspect herein.

Aspect 23: A combination of any two or more preceding aspects or any portion(s) thereof.

### EXAMPLES

The following examples illustrate non-limiting aspects of the disclosure and are not intended to be limiting on the scope of the disclosure or claims.

### Example 1: This Example Demonstrates Glass Compositions that were Prepared and Analyzed

The glass compositions included the components listed in Table 1 below and were prepared by conventional glass forming methods to make glass coupons. In Table 1, all components are in mol %. The liquidus temperature, liquidus viscosity, and softening point were measured according to the method described elsewhere herein. The Poisson's ratio (v), the Young's modulus (E), and the shear modulus (G) of the glass compositions were measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.” The refractive index at 589.3 nm and stress optical coefficient (SOC) of the substrates are also reported in Table 1. The refractive index was measured using a PerkinElmer 950 spectrometer. The SOC was measured according to Procedure C (Glass Disc Method) described in ASTM standard C770-16, entitled “Standard Test Method for Measurement of Glass Stress-Optical Coefficient.” The density of the glass compositions was determined using the buoyancy method of ASTM C693-93(2013). The annealing point is the temperature at which the viscosity of the glass composition is 1×10¹³ poise, and the strain point is the temperature at which the viscosity of the glass composition is 1×10^{14.68} poise. Annealing point and strain point are measured by beam bending viscosity (BBV) or fiber elongation (FE). Blank cells in Table 1 for compositional components mean the component was not detected in a measurable quantity using routine/standard compositional measurements techniques, or that the component was not measured for given that it should be absent in view of the batch recipe. Blank cells in Table 1 for properties mean the property was not measured.

The ISO720 standard is a measure of the resistance of the glass to degradation in purified, CO₂-free water. In brief, the ISO720 standard protocol utilizes crushed glass grains which are placed in contact with the purified, CO₂-free water under autoclave conditions (121° C., 2 atm) for 30 minutes. The solution is then titrated colorimetrically with dilute HCl to neutral pH. The amount of HCl required to titrate to a neutral solution is then converted to an equivalent of Na₂O extracted from the glass and reported in g Na₂O per mass of glass with smaller values indicative of greater durability. The ISO720 standard is broken into individual types. Type HGA1 is indicative of up to 62 μg extracted equivalent of Na₂O per gram of glass tested; Type HGA2 is indicative of more than 62 μg and up to 527 μg extracted equivalent of Na₂O per gram of glass tested; and Type HGA3 is indicative of more than 527 μg and up to 930 μg extracted equivalent of Na₂O per gram of glass tested.

The 85° C./85% RH test is a visual test that measures hydrolytic durability of a glass by subjecting a glass to 85° C. and 85% relative humidity (RH) for a given time period as reported in the data tables herein, and the visually inspecting the resulting glass in terms of whether any visual change is apparent (e.g., haze, surface reaction, transparency, etc.).

TABLE 1

| Analyzed (mol %) | 1 | 2 | 3 | 4 | 5 | 6 |
|---|---|---|---|---|---|---|
| P₂O₅ | 52.8 | 43.2 | 38.2 | 33.2 | 36.8 | 31.9 |
| Al₂O₃ | 13.0 | 13.1 | 13.1 | 13.2 | 15.7 | 18.3 |
| B₂O₃ | | | | | | |
| Li₂O | | | | | | |
| Na₂O | 0.3 | 0.3 | 0.3 | 0.3 | 0.2 | 0.2 |
| K₂O | 16.0 | 21.4 | 21.6 | 21.5 | 22.8 | 24.1 |
| MgO | | | | | | |
| CaO | | | | | | |
| SrO | | | | | | |
| BaO | 12.4 | 16.7 | 16.3 | 16.1 | 17.1 | 18.0 |
| TiO₂ | 5.0 | 5.0 | 10.0 | 14.9 | 5.1 | 5.1 |
| SiO₂ | 0.5 | 0.1 | 0.1 | 0.3 | 2.2 | 2.4 |
| Sum | 99.9 | 99.8 | 99.5 | 99.5 | 99.9 | 99.9 |
| CaO + SrO + BaO | 12.4 | 16.7 | 16.3 | 16.1 | 17.1 | 18.0 |
| Li₂O + Na₂O + K₂O | 16.3 | 21.8 | 21.9 | 21.8 | 23.0 | 24.3 |
| P₂O₅ + Al₂O₃ + B₂O₃ | 56.3 | 56.3 | 51.3 | 46.5 | 52.5 | 50.2 |
| P₂O₅ + Al₂O₃ | 56.3 | 56.3 | 51.3 | 46.5 | 52.5 | 50.2 |
| R₂O + RO + SnO₂ + MnO₂ | 28.7 | 38.4 | 38.2 | 37.9 | 40.1 | 42.3 |

Properties

| | | | | | | |
|---|---|---|---|---|---|---|
| Density (g/cm³) | | | | | 2.952 | 2.949 |
| Refractive Index | 1.5541 | 1.5570 | 1.5762 | 1.5964 | | |
| Stress Optic Coefficient | 2.081 | 1.808 | 2.017 | 1.941 | | |
| (nm/mm/MPa) | | | | | | |
| Poissons Ratio | 0.244 | 0.263 | 0.256 | 0.251 | 0.260 | 0.261 |
| E (Young's Modulus, | 58.8 | 53.0 | 53.3 | 55.5 | 51.4 | 49.3 |
| GPa) | | | | | | |
| G (Shear Modulus, GPa) | 23.6 | 21.0 | 21.2 | 22.2 | 20.4 | 19.6 |
| Strain Point (° C., BBV) | 477 | 457 | 465 | 511 | 430 | 453 |
| Annealing Point (° C., | 508 | 488 | 497 | 544 | 462 | 488 |
| BBV) | | | | | | |
| Softening Point (° C., PPV) | 606 | 575 | 599 | 641 | 566 | 599 |
| VFT Coefficient - A | | | | | −4.250 | −0.986 |
| VFT Coefficient - B | | | | | 12057.7 | 1630 |
| VFT Coefficient - To | | | | | −1072.4 | 415.7 |
| Temp. at 200 P (° C.) | | | | | 768 | 912 |
| Liquidus (° C.) | 1345 | 1325 | 1125 | 955 | 895 | 920 |
| Liquidus Viscosity (P) | | | | | 76 | 176 |
| ISO720 | No data | HGA1 | HGA1 | HGA1 | HGA1 | |
| ISO720 (μg Na₂O/g | No data | 12 | 20 | 30 | 32 | |
| sample) | | | | | | |
| 85° C./85% RH - 24 h | | | | | | |
| (polished coupons) | | | | | | |
| 85° C./85% RH - 7 days | No | No | No | No | No | No |
| (chunks) | change | change | change | change | change | change |
| 85° C./85% RH - 2 weeks | | | | | No | |
| (polished coupons) | | | | | change | |
| 85° C./85% RH - 4 weeks | | | | | No | |
| (polished coupons) | | | | | change | |
| Avg. Transmittance 400- | | | | | 90.8 | |
| 1600 nm (%) | | | | | | |
| Avg. Transmittance 400- | | | | | 90.3 | |
| 700 nm (%) | | | | | | |
| Avg. Transmittance 700- | | | | | 90.9 | |
| 1600 nm (%) | | | | | | |

| Analyzed (mol %) | 7 | 8 | 9 | 10 | 11 | 12 |
|---|---|---|---|---|---|---|
| P₂O₅ | 27.3 | 32.1 | 27.3 | 28.6 | 28.2 | 27.8 |
| Al₂O₃ | 20.6 | 13.4 | 13.4 | 19.5 | 20.5 | 22.2 |
| B₂O₃ | | | | 4.9 | 9.8 | 14.9 |
| Li₂O | | | | | | |
| Na₂O | 0.2 | 0.2 | 0.2 | 0.4 | 0.3 | 0.2 |
| K₂O | 25.9 | 27.0 | 26.9 | 22.9 | 19.7 | 15.9 |
| MgO | | | | | | |
| CaO | | | | 0.1 | 0.1 | 0.1 |
| SrO | | | | | | |
| BaO | 18.7 | 20.0 | 19.9 | 18.1 | 15.8 | 12.9 |
| TiO₂ | 5.1 | 5.1 | 10.2 | 4.9 | 5.0 | 5.1 |
| SiO₂ | 2.1 | 2.1 | 2.1 | 0.5 | 0.7 | 0.9 |
| Sum | 99.9 | 99.9 | 99.9 | 100.0 | 100.0 | 100.0 |
| CaO + SrO + BaO | 18.7 | 20.0 | 19.9 | 18.3 | 15.9 | 13.0 |
| Li₂O + Na₂O + K₂O | 26.2 | 27.2 | 27.1 | 23.3 | 20.0 | 16.1 |
| P₂O₅ + Al₂O₃ + B₂O₃ | 47.9 | 45.5 | 40.6 | 53.0 | 58.4 | 65.0 |
| P₂O₅ + Al₂O₃ | 47.9 | 45.5 | 40.6 | 48.1 | 48.7 | 50.0 |
| R₂O + RO + SnO₂ + MnO₂ | 44.8 | 47.2 | 47 | 41.5 | 35.9 | 29.1 |

Properties

| | | | | | | |
|---|---|---|---|---|---|---|
| Density (g/cm³) | 2.964 | 3.001 | 3.052 | 2.893 | 2.852 | 2.77 |
| Poissons Ratio | 0.265 | 0.273 | 0.275 | 0.261 | 0.256 | 0.255 |
| E (Young's Modulus, | 49.5 | 46.9 | 49.3 | 48.5 | 50.2 | 52.2 |
| GPa) | | | | | | |
| G (Shear Modulus, GPa) | 19.6 | 18.4 | 19.3 | 19.2 | 20.0 | 20.8 |
| Strain Point (° C., BBV) | 459 | 430 | 460 | | | |
| Annealing Point (° C., | 501 | 463 | 498 | | | |
| BBV) | | | | | | |
| Softening Point (° C., | 622 | | 591 | 600 | 592 | 590 |
| PPV) | | | | | | |
| VFT Coefficient - A | −1.627 | −0.678 | −2.373 | | | |
| VFT Coefficient - B | 2319.2 | 1086.9 | 3621.1 | | | |
| VFT Coefficient - To | 381.2 | 455.7 | 62.1 | | | |
| Temp. at 200 P (° C.) | 972 | 821 | 837 | | | |
| Liquidus (° C.) | 905 | 845 | 870 | 900 | 875 | 895 |
| Liquidus Viscosity (P) | 632 | 130 | 129 | | | |
| ISO720 | HGA2 | HGA3 | HGA3+ | HGA2 | HGA2 | HGA1 |
| ISO720 (μg Na₂O/g | 136 | 701 | 1735 | 197 | 69 | 26 |
| sample) | | | | | | |
| 85° C./85% RH - 24 h | | | | | | |
| (polished coupons) | | | | | | |
| 85° C./85% RH - 7 days | | No | Light | | | |
| (chunks) | | change | surface | | | |
| | | | reaction | | | |
| | | | on | | | |
| | | | fractured | | | |
| | | | surfaces | | | |
| 85° C./85% RH - 2 weeks | | Light | | | | |
| (polished coupons) | | surface | | | | |
| | | haze | | | | |
| 85° C./85% RH - 4 weeks | | Light | | | | |
| (polished coupons) | | surface | | | | |
| | | haze | | | | |

| Analyzed (mol %) | 13 | 14 | 15 | 16 | 17 | 18 |
|---|---|---|---|---|---|---|
| P₂O₅ | 27.6 | 27.6 | 27.5 | 28.7 | 28.2 | 28.0 |
| Al₂O₃ | 20.2 | 20.0 | 19.2 | 21.1 | 20.8 | 20.9 |
| B₂O₃ | | | | | | |
| Li₂O | | 12.7 | | | | |
| Na₂O | 25.0 | 12.7 | 0.2 | | | |
| K₂O | | | 23.9 | 25.3 | 25.6 | 26.2 |
| MgO | | | | | | |
| CaO | 0.1 | 0.1 | 0.2 | 0.3 | 9.3 | 19.3 |
| SrO | | | 9.4 | 17.8 | 9.1 | |
| BaO | 19.6 | 19.7 | 9.7 | 0.2 | 0.1 | |
| TiO₂ | 5.0 | 5.0 | 4.8 | 5.0 | 5.1 | 5.3 |
| SiO₂ | 2.3 | 2.1 | 5.1 | 1.6 | 1.8 | 0.3 |
| Sum | 99.9 | 100.0 | 100.0 | 100.0 | 100.0 | 100.0 |
| CaO + SrO + BaO | 19.8 | 19.8 | 19.3 | 18.2 | 18.5 | 19.3 |
| Li₂O + Na₂O + K₂O | 25.0 | 25.4 | 24.1 | 25.3 | 25.7 | 26.2 |
| P₂O₅ + Al₂O₃ + B₂O₃ | 47.8 | 47.6 | 46.7 | 49.8 | 49.0 | 48.9 |
| P₂O₅ + Al₂O₃ | 47.8 | 47.6 | 46.7 | 49.8 | 49.0 | 48.9 |
| R₂O + RO + SnO₂ + MnO₂ | 44.8 | 32.6 | 43.6 | 43.9 | 53.4 | 64.8 |

Properties

| | | | | | | |
|---|---|---|---|---|---|---|
| Density (g/cm³) | 3.123 | 3.178 | 2.886 | 2.778 | 2.681 | 2.586 |
| Refractive Index | | | 1.5446 | 1.5357 | 1.5345 | 1.5323 |
| Poissons Ratio | 0.259 | 0.255 | 0.256 | 0.259 | 0.252 | 0.256 |
| E (Young's Modulus, | 62.5 | 79.0 | 51.6 | 51.9 | 53.4 | 53.2 |
| GPa) | | | | | | |
| G (Shear Modulus, GPa) | 24.8 | 31.5 | 20.5 | 20.6 | 21.3 | 21.2 |
| Strain Point (° C., BBV) | | 431 | | 488 | 491 | 492 |
| Annealing Point (° C., | | 459 | | 526 | 530 | 528 |
| BBV) | | | | | | |
| Softening Point (° C., | 564 | 538 | 655 | 660 | 659 | 660 |
| PPV) | | | | | | |
| Liquidus (° C.) | 1175 | 1320 | | | | |
| ISO720 | HGA2 | HGA2 | HGA3 | HGA3 | HGA2 | HGA2 |
| ISO720 (μg Na₂O/g | 210 | 80 | 758 | 549 | 236 | 216 |
| sample) | | | | | | |
| 85° C./85% RH - 24 h | | | | | | |
| (polished coupons) | | | | | | |
| 85° C./85% RH - 7 days | | | | | | |
| (chunks) | | | | | | |
| 85° C./85% RH - 2 weeks | | | | | | |
| (polished coupons) | | | | | | |
| 85° C./85% RH - 4 weeks | | | | | | |
| (polished coupons) | | | | | | |

| Analyzed (mol %) | 19 | 20 | 21 | 22 | 23 | 24 |
|---|---|---|---|---|---|---|
| P₂O₅ | 28.1 | 28.5 | 38.4 | 36.0 | 33.4 | 30.9 |
| Al₂O₃ | 21.2 | 21.2 | 21.1 | 18.4 | 20.7 | 23.0 |
| B₂O₃ | | 4.9 | | | | |
| Li₂O | | | | | | |
| Na₂O | 0.1 | 0.1 | 0.4 | 0.4 | 0.4 | 0.4 |
| K₂O | 25.2 | 21.8 | 22.5 | 22.7 | 22.8 | 23.2 |
| MgO | | | | | | |
| CaO | 6.2 | 5.6 | 0.1 | 0.1 | 0.1 | 0.1 |
| SrO | 6.0 | 5.9 | 0.0 | 0.0 | 0.0 | 0.0 |
| BaO | 6.6 | 6.0 | 17.3 | 17.3 | 17.5 | 17.3 |
| TiO₂ | 5.1 | 5.1 | 0.0 | 5.0 | 4.9 | 5.0 |
| SiO₂ | 1.5 | 0.8 | 0.1 | 0.1 | 0.1 | 0.1 |
| Sum | 100.0 | 100.0 | 99.9 | 99.9 | 99.8 | 99.9 |
| CaO + SrO + BaO | 18.8 | 17.5 | 17.3 | 17.4 | 17.5 | 17.3 |
| Li₂O + Na₂O + K₂O | 25.3 | 22.0 | 22.9 | 23.1 | 23.2 | 23.6 |
| P₂O₅ + Al₂O₃ + B₂O₃ | 49.3 | 54.7 | 59.5 | 54.3 | 54.1 | 53.9 |
| P₂O₅ + Al₂O₃ | 49.3 | 49.8 | 59.5 | 54.3 | 54.1 | 53.9 |
| R₂O + RO + SnO₂ + MnO₂ | 44.1 | 39.4 | 40.3 | 40.5 | 40.8 | 41 |
| Density (g/cm³) | 2.781 | 2.741 | 2.894 | 2.934 | 2.92 | 2.908 |
| Refractive Index | 1.5393 | 1.5360 | | | | |
| Poissons Ratio | 0.258 | 0.256 | 0.262 | 0.260 | 0.260 | 0.260 |
| E (Young's Modulus, | 52.7 | 51.3 | 48.7 | 50.5 | 50.8 | 51.8 |
| GPa) | | | | | | |
| G (Shear Modulus, GPa) | 21.0 | 20.4 | 19.3 | 20.0 | 20.2 | 20.6 |
| Strain Point (° C., BBV) | | | 413 | 442 | | 454 |
| Annealing Point (° C., | | | 446 | 474 | | 491 |
| BBV) | | | | | | |
| Softening Point (° C., PPV) | 652 | 638 | 561 | 590 | 605 | 626 |
| VFT Coefficient - A | | | −0.253 | | −0.883 | −1.238 |
| VFT Coefficient - B | | | 1135.7 | | 1678.3 | 2112.1 |
| VFT Coefficient - To | | | 461.6 | | 422.4 | 396.3 |
| Temp. at 200 P (° C.) | | | 837 | | 837 | 837 |
| Liquidus (° C.) | | | 905 | 895 | 875 | 945 |
| Liquidus Viscosity (P) | | | 203 | | 669 | 409 |
| ISO720 | HGA2 | HGA2 | | | | |
| ISO720 (μg Na₂O/g | 259 | 78 | | | | |
| sample) | | | | | | |
| 85° C./85% RH - 24 h | | | | | | |
| (polished coupons) | | | | | | |
| 85° C./85% RH - 7 days | | | | | | |
| (chunks) | | | | | | |
| 85° C./85% RH - 2 weeks | | | | | | |
| (polished coupons) | | | | | | |
| 85° C./85% RH - 4 weeks | | | | | | |
| (polished coupons) | | | | | | |

| Analyzed (mol %) | 25 | 26 | 27 | 28 | 29 |
|---|---|---|---|---|---|
| P₂O₅ | 59.1 | 59.4 | 59.8 | 59.5 | 59.3 |
| Al₂O₃ | 12.5 | 17.9 | 23.6 | 11.8 | 11.9 |
| B₂O₃ | | | | | |
| Li₂O | | | | 2.2 | |
| Na₂O | 0.4 | 0.4 | 0.3 | 0.4 | 0.4 |
| K₂O | 11.6 | 10.1 | 7.1 | 10.9 | 11.0 |
| MgO | 0.3 | 0.3 | 0.2 | | |
| CaO | 0.1 | 0.1 | 0.1 | 0.1 | 0.1 |
| SrO | 0.4 | 0.3 | 0.2 | 0.4 | 0.4 |
| BaO | 15.2 | 11.3 | 8.3 | 14.5 | 14.6 |
| TiO₂ | | | | | 2.1 |
| SiO₂ | 0.3 | 0.3 | 0.3 | 0.2 | 0.2 |
| Sum | 100.0 | 100.0 | 100.0 | 100.0 | 100.0 |
| CaO + SrO + BaO | 16.0 | 12.0 | 8.8 | 15.0 | 15.0 |
| Li₂O + Na₂O + K₂O | 12.0 | 10.5 | 7.4 | 13.5 | 11.4 |
| P₂O₅ + Al₂O₃ + B₂O₃ | 59.5 | 59.5 | 59.5 | 59.5 | 59.5 |
| P₂O₅ + Al₂O₃ | 54.3 | 54.3 | 54.3 | 54.3 | 54.3 |
| R₂O + RO + SnO₂ + MnO₂ | 28 | 22.5 | 16.2 | 28.5 | 26.5 |

Properties

| | | | | | |
|---|---|---|---|---|---|
| Density (g/cm³) | 2.853 | 2.8 | 2.728 | 2.845 | 2.848 |
| Refractive Index | 1.5318 | 1.5305 | 1.5252 | 1.5334 | 1.5411 |
| Poissons Ratio | | | | 0.246 | 0.242 |
| E (Young's Modulus, | | | | 58.3 | 57.3 |
| GPa) | | | | | |
| G (Shear Modulus, GPa) | | | | 23.4 | 23.1 |
| Strain Point (° C., BBV) | 476 | 508 | 534 | 485 | 480 |
| Annealing Point (° C., | 507 | 540 | 567 | 454 | 512 |
| BBV) | | | | | |
| Softening Point (° C., PPV) | 607 | 646 | | 591 | 621 |
| Liquidus (° C.) | 1255 | >1485 | | 1380 | 1455 |
| ISO720 | | | | | |
| ISO720 (μg Na₂O/g | | | | | |
| sample) | | | | | |
| 85° C./85% RH - 24 h | light | light | light | light | light |
| (polished coupons) | surface | surface | surface | surface | surface |
| | reaction | reaction | reaction | reaction | reaction |
| 85° C./85% RH - 7 days | surface | light | light | surface | surface |
| (polished coupons) | reaction | surface | surface | reaction | reaction |
| | | reaction | reaction | | |
| 85° C./85% RH - 2 weeks | | | | | |
| (polished coupons) | | | | | |
| 85° C./85% RH - 4 weeks | | | | | |
| (polished coupons) | | | | | |

| Analyzed (mol %) | 30 | 31 | 32 | 33 | 34 | 35 |
|---|---|---|---|---|---|---|
| P₂O₅ | 59.1 | 59.5 | 59.5 | 59.2 | 26.2 | 26.7 |
| Al₂O₃ | 11.8 | 13.9 | 13.9 | 13.9 | 24.7 | 24.2 |
| B₂O₃ | | | | | 15.7 | 20.4 |
| Li₂O | 2.2 | 2.2 | | 2.2 | | |
| Na₂O | 0.4 | 0.4 | 0.4 | 0.4 | 0.3 | 0.2 |
| K₂O | 9.1 | 10.0 | 10.0 | 8.1 | 19.8 | 17.0 |
| MgO | | | | | | |
| CaO | 0.1 | 0.1 | 0.1 | 0.1 | | |
| SrO | 0.4 | 0.4 | 0.4 | 0.3 | | |
| BaO | 14.4 | 13.5 | 13.5 | 13.5 | 13.1 | 11.2 |
| TiO₂ | 2.1 | | 2.1 | 2.1 | | |
| SiO₂ | 0.5 | 0.2 | 0.2 | 0.2 | 0.1 | 0.1 |
| Sum | 100.0 | 100.0 | 100.0 | 100.0 | 99.9 | 99.9 |
| CaO + SrO + BaO | 14.9 | 13.9 | 13.9 | 13.9 | 13.1 | 11.2 |
| Li₂O + Na₂O + K₂O | 11.6 | 12.5 | 10.4 | 10.6 | 20.1 | 17.2 |
| P₂O₅ + Al₂O₃ + B₂O₃ | 59.5 | 59.5 | 59.5 | 59.5 | 66.6 | 71.3 |
| P₂O₅ + Al₂O₃ | 54.3 | 54.3 | 54.3 | 54.3 | 50.9 | 50.9 |
| R₂O + RO + SnO₂ + MnO₂ | 26.6 | 26.6 | 24.4 | 24.6 | 33.2 | 28.4 |

Properties

| | | | | | | |
|---|---|---|---|---|---|---|
| Density (g/cm³) | 2.859 | 2.839 | 2.839 | 2.852 | 2.779 | 2.663 |
| Refractive Index | 1.5451 | 1.5344 | 1.542 | 1.5456 | 1.5200 | 1.5157 |
| Poissons Ratio | 0.239 | 0.236 | 0.242 | 0.235 | 0.252 | 0.258 |
| E (Young's Modulus, | 60.9 | 62.7 | 61.2 | 64.6 | 46.0 | 47.0 |
| GPa) | | | | | | |
| G (Shear Modulus, GPa) | 24.6 | 25.1 | 24.6 | 26.1 | 18.4 | 18.7 |
| Strain Point (° C., BBV) | 467 | 469 | 496 | 483 | | 418 |
| Annealing Point (° C., | 498 | 501 | 529 | 514 | | 453 |
| BBV) | | | | | | |
| Softening Point (° C., | 610 | 605 | 639 | 627 | 564 | 572 |
| PPV) | | | | | | |
| VFT Coefficient - A | | | | | −0.75 | 0.447 |
| VFT Coefficient - B | | | | | 1573.3 | 534.6 |
| VFT Coefficient - Tₒ | | | | | 397.8 | 627.6 |
| Temp. at 200 P (° C.) | | | | | 913 | 916 |
| Liquidus (° C.) | ~1075 | 1255 | >1595 | 1390 | 865 | 945 |
| Liquidus Viscosity (P) | | | | | 414 | 135 |
| ISO720 | | | | | HGA2 | HGA2 |
| ISO720 (μg Na₂O/g | | | | | 295 | 143 |
| sample) | | | | | | |
| 85° C./85% RH - 24 h | light | light | light | light | | |
| (polished coupons) | surface | surface | surface | surface | | |
| | reaction | reaction | reaction | reaction | | |
| 85° C./85% RH - 7 days | surface | surface | surface | surface | | |
| (polished coupons) | reaction | reaction | reaction | reaction | | |
| 85° C./85% RH - 2 weeks | | | | | | |
| (polished coupons) | | | | | | |
| 85° C./85% RH - 4 weeks | | | | | | |
| (polished coupons) | | | | | | |

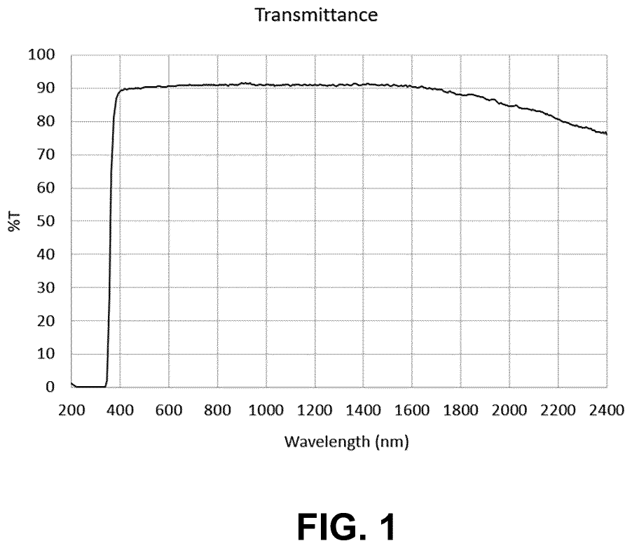

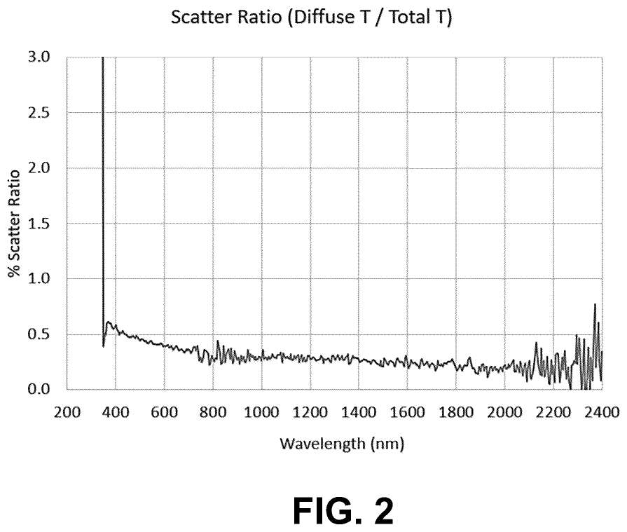

The transmittance and scatter ratio was measured for glass composition 5, with the results shown in FIG. 1 and FIG. 2, respectively.

The compositions in Table 1 generally are durable, transparent, and have a low liquidus temperature. The most durable compositions have an HGA1 categorization via the ISO720 test (e.g., hydrolytic resistance of glass grains at 121° C. as described in detail elsewhere herein), and have no apparent surface reaction after exposure to 85% relative humidity and 85° C., which is a harsh durability test. When composition 5 was subjected to the 85% RH/85° C. durability test for 2 weeks, the glass coupon showed no change in appearance (i.e., no haze or transparency was visibly apparent). In contrast, when composition 8 was subject to the 85% RH/85° C. durability test for 2 weeks, the glass coupon showed a light surface haze indicating such a composition is less durable than composition 5. In addition, when Comparative Compositions A and B having the batched compositions shown in Table 2 were prepared, phase separation was observed, leading to a glass that was not transparent.

TABLE 2

| Batched (mol %) | Comp. A | Comp. B |
|---|---|---|
| P₂O₅ | 28.3 | 31.3 |
| Al₂O₃ | 21.0 | 23.0 |
| B₂O₃ | 25.0 | 15.0 |
| K₂O | 14.0 | 17.0 |
| BaO | 11.7 | 13.7 |
| Sum | 100.0 | 100.0 |
| CaO + SrO + BaO | 11.7 | 13.7 |
| Li₂O + Na₂O + K₂O | 14 | 17 |
| P₂O₅ + Al₂O₃ + B₂O₃ | 74.3 | 69.3 |
| P₂O₅ + Al₂O₃ | 49.3 | 54.3 |
| R₂O + RO + SnO₂ + MnO₂ | 25.7 | 30.7 |

It will be appreciated that the various disclosed aspects or embodiments may involve particular features, elements or steps that are described in connection with that particular aspect or embodiment. It will also be appreciated that a particular feature, element, or step, although described in relation to one particular aspect or embodiment, may be interchanged or combined with alternate aspects or embodiments in various non-illustrated combinations or permutations.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

While various features, elements, or steps of particular aspects or embodiments may be disclosed using the transitional phrase “comprising,” it is to be understood that alternative aspects or embodiments, including those that may be described using the transitional phrases “consisting of” or “consisting essentially of,” are implied. Thus, for example, implied alternative aspects or embodiments to a device that comprises A+B+C include aspects or embodiments where a device consists of A+B+C and aspects or embodiments where a device consists essentially of A+B+C.

References herein to the positions of elements (e.g., “top,” “bottom,” “above,” “below,” “first,” “second,” etc.) are merely used to describe the orientation of various elements in the FIGURES. It should be noted that the orientation of various elements may differ according to other exemplary embodiments, and that such variations are intended to be encompassed by the present disclosure. Moreover, these relational terms are used solely to distinguish one entity or action from another entity or action, without necessarily requiring or implying any actual such relationship or order between such entities or actions.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described component, event, or circumstance can or cannot occur or be present, and that the description includes instances where the component, event, or circumstance occurs/is present and instances where it does not occur/is not present. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be apparent to those ordinarily skilled in the art that various modifications and variations can be made to the present disclosure without departing from the spirit and scope of the disclosure. Since modifications combinations, sub-combinations, and variations of the disclosed embodiments incorporating the spirit and substance of the disclosure may occur to persons ordinarily skilled in the art, the disclosure should be construed to include everything within the scope of the appended claims and their equivalents.

What is claimed is:

1. A glass, comprising: 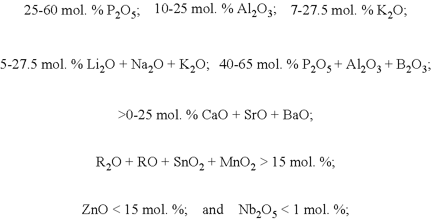
wherein R₂O is total amount in mol. % of Li₂O, Na₂O, K₂O, Rb₂O, and Cs₂O; and
wherein RO is total amount in mol. % of MgO, CaO, SrO, and BaO.

2. The glass of claim 1, wherein the glass is a single-phase glass.

3. The glass of claim 1, wherein the glass has an average transmittance of at least 88% from 400 nm to 700 nm.

4. The glass of claim 1, comprising a liquidus temperature of 800-1600° C.

5. The glass of claim 1, comprising a temperature at 200 P of 700-1000° C.

6. The glass of claim 1, wherein the glass exhibits a type HGA1 or HGA 2 hydrolytic resistance according to ISO 720.

7. The glass of claim 1, wherein the glass exhibits a type HGA1 hydrolytic resistance according to ISO 720.

8. The glass of claim 1, wherein P₂O₅+Al₂O₃ is present in an amount of 50-59.5 mol. %.

9. The glass of claim 1, wherein P₂O₅ is present in an amount of 35 mol. % or less.

10. The glass of claim 1, wherein at least two oxides selected from the group consisting of Li₂O, Na₂O, and K₂O are present.

11. The glass of claim 1, wherein:
P₂O₅ is present in an amount of 25-45 mol. %;
Al₂O₃ is present in an amount of 10-20 mol. %;
K₂O is present in an amount of 12-25 mol. %;
Li₂O+Na₂O+K₂O is present in an amount of 15-25 mol. %;
P₂O₅+Al₂O₃+B₂O₃ is present in an amount of 50-60 mol. %;
CaO+SrO+BaO is present in an amount of 14-20 mol. %; and
R₂O+RO+SnO₂+MnO₂ is present in an amount of 16-70 mol. %;
wherein R₂O is total amount in mol. % of Li₂O, Na₂O, K₂O, Rb₂O, and Cs₂O; and
wherein RO is total amount in mol. % of MgO, CaO, SrO, and BaO.

12. The glass of claim 1:
wherein B₂O₃ is present in an amount of 0-20 mol. %;
wherein Li₂O is present in an amount of 0-15 mol. %;
wherein Na₂O is present in an amount of 0-25 mol. %;
wherein CaO is present in an amount of 0-20 mol. %;
wherein SrO is present in an amount of 0-20 mol. %;
wherein BaO is present in an amount of 0-20 mol. %;
wherein TiO₂ is present in an amount of 0-15 mol. %; and
wherein SiO₂ is present in an amount of 0-15 mol. %.

13. The glass of claim 1, wherein:
wherein P₂O₅ is present in an amount 25-45 mol. %;
wherein Al₂O₃ is present in an amount 10-18 mol. %;
wherein K₂O is present in an amount 15-23 mol. %;
wherein BaO is present in an amount 10-20 mol. %;
wherein TiO₂ is present in an amount 5-15; and
wherein SiO₂ is present in an amount >0-5 mol. %;

14. The glass of claim 1, wherein at least one of the following is satisfied:
wherein B₂O₃ is present in an amount of 4-16 mol. %;
wherein Li₂O is present in an amount of >0-10 mol. %;
wherein Na₂O is present in an amount of >0-8 mol. %;
wherein CaO is present in an amount of >0-5 mol. %;
wherein SrO is present in an amount of 0-5 mol. %;
wherein BaO is present in an amount of 10-18 mol. %;
wherein TiO₂ is present in an amount of 2-8 mol. %;
wherein SiO₂ is present in an amount of >0-5 mol. %;
or any combination thereof.

15. The glass of claim 1, comprising 0.5 mol. % or less of each of Fe₂O₃ and PbO.

16. A method for ion-exchanging a glass-based substrate, the method comprising:
ion-exchanging the glass-based substrate in an ion exchange medium to form a glass-based article,
wherein the glass-based article comprises a compressive stress layer extending from a surface of the glass-based article to a depth of compression, the glass-based article comprises a central tension region, and the glass-based substrate comprises the glass of claim 1.

17. The method of claim 16, wherein the ion exchange medium comprises a molten salt bath comprising NaNO₃, KNO₃, Ca(NO₃)₂, or any combination thereof.

18. The method of claim 16, wherein the ion exchange medium comprises a molten salt bath comprising a mixed salt eutectic bath comprising KNO₃ and Ca(NO₃)₂.

19. The method of claim 16, wherein the ion-exchanging is conducted at a temperature of 150-550° C. for a time period of 2-16 hours.

20. A glass-based article, comprising:
a compressive stress layer extending from a surface of the glass-based article to a depth of compression;
a central tension region; and
a composition at a center of the glass-based article comprising the glass of claim 16.
